(19) United States
(12) Patent Application Publication
(10) Pub. No.: US 2011/0060709 A1
(43) Pub. Date: Mar. 10, 2011

(54) DATA PROCESSING APPARATUS, DATA PROCESSING METHOD, AND PROGRAM

(76) Inventors: Naoki Ide, Tokyo (JP); Masato Ito, Tokyo (JP); Kohtaro Sabe, Tokyo (JP)

(21) Appl. No.: 12/874,553

(22) Filed: Sep. 2, 2010

(30) Foreign Application Priority Data
Sep. 9, 2009 (JP) P2009-208064

(51) Int. Cl. G06F 15/18

(52) U.S. Cl. 706/12

(57) ABSTRACT

A data processing apparatus includes an action learning unit configured to train a user activity model representing activity states of a user in the form of a probabilistic state transition model using time-series location data items of the user, an action recognizing unit configured to recognize a current location of the user using the user activity model obtained through the action learning unit, an action estimating unit configured to estimate a possible route for the user from the current location recognized by the action recognizing unit and a selection probability of the route, and a travel time estimating unit configured to estimate an arrival probability of the user arriving at a destination and a travel time to the destination using the estimated route and the estimated selection probability.

### BACKGROUND OF THE INVENTION

1. Field of the Invention

The present invention relates to a data processing apparatus, a data processing method, and a program and, in particular, to a data processing apparatus, a data processing method, and a program that compute a route to a destination and a travel time to the destination by training a probabilistic state transition model representing the activity states of the user using acquired time-series data items.

2. Description of the Related Art

In recent years, many researches for modeling the state of a user using time-series data items acquired from a wearable sensor, which the user can wear, learning the user state, and recognizing the current state of the user using the model obtained through the learning have been conducted (refer to, for example, Japanese Unexamined Patent Application Publication Nos. 2006-134080 and 2008-204040 and “Life Patterns: structure from wearable sensors”, Brian Patrick Clarkson, Doctor Thesis, MIT, 2002).

In addition, the present inventors previously proposed a method for probabilistically estimating a plurality of possible activity states of a user at a desired future time as Japanese Patent Application No. 2009-180780. In this method, the user's activity states are learned and modeled into a probabilistic state transition model using time-series data items. Thereafter, the current activity state can be recognized using the trained probabilistic state transition model, and the user activity state at a point in time after a “predetermined period of time” elapses can be probabilistically estimated. In Japanese Patent Application No. 2009-180780, as an example of estimation of the user activity after a “predetermined period of time” elapses, the current location of the user is recognized, and the destination (the location) of the user after the “predetermined period of time” elapses is estimated.

### SUMMARY OF THE INVENTION

In some cases, the destination (the location) of a user after a predetermined period of time elapses is estimated. However, in most cases, the destination is determined in advance, and it is desirable that a route and a period of time necessary for the user to reach the destination be obtained.

However, in the method described in Japanese Patent Application No. 2009-180780, it is difficult to obtain a route and a period of time necessary for the user to reach the destination unless a “predetermined period of time” (i.e., an elapsed time from the current time) is provided.

Accordingly, the present invention provides a data processing apparatus, a data processing method, and a program that provides a route and a travel time for a user to arrive at the destination by learning the activity states of the user using a probabilistic state transition model and acquired time-series data items.

According to an embodiment of the present invention, a data processing apparatus includes action learning means for training a user activity model representing activity states of a user in the form of a probabilistic state transition model using time-series location data items of the user, action recognizing means for recognizing a current location of the user using the user activity model obtained through the action learning means, action estimating means for estimating a possible route for the user from the current location recognized by the action recognizing means and a selection probability of the route, and travel time estimating means for estimating an arrival probability of the user arriving at a destination and a travel time to the destination using the estimated route and the estimated selection probability.

According to another embodiment of the present invention, a data processing method for use in a data processing apparatus that processes time-series data items is provided. The data processing method includes the steps of training a user activity model representing activity states of a user in the form of a probabilistic state transition model using time-series location data items of the user, recognizing a current location of the user using the user activity model obtained through learning, estimating a possible route for the user from the recognized current location of the user and a selection probability of the route, and estimating an arrival probability of the user arriving at a destination and a travel time to the destination using the estimated route and the estimated selection probability.

According to still another embodiment of the present invention, a program includes program code for causing a computer to function as action learning means for training a user activity model representing activity states of a user in the form of a probabilistic state transition model using time-series location data items of the user, action recognizing means for recognizing a current location of the user using the user activity model obtained through the action learning means, action estimating means for estimating a possible route for the user from the current location recognized by the action recognizing means and a selection probability of the route, and travel time estimating means for estimating an arrival probability of the user arriving at a destination and a travel time to the destination using the estimated route and the estimated selection probability.

According to the embodiments of the present invention, a user activity model representing activity states of a user in the form of a probabilistic state transition model is trained using time-series location data items of the user. A current location of the user is recognized using the user activity model obtained through the learning. A possible route for the user from the recognized current location and a selection probability of the route are estimated. An arrival probability of the user arriving at a destination and a travel time to the destination are estimated using the estimated route and the estimated selection probability.

According to the embodiments of the present invention, the activity states of a user is learned in the form of a probabilistic state transition model using time-series location data items, and the route and travel time to the destination can be obtained.

### BRIEF DESCRIPTION OF THE DRAWINGS

FIG. 1 is a block diagram illustrating an exemplary configuration of an estimation system according to a first embodiment of the present invention;

FIG. 2 is a block diagram illustrating an exemplary hardware configuration of the estimation system;

FIG. 3 illustrates an example of time-series data items input to the estimation system;

FIG. 4 illustrates an example of an HMM;

FIG. 5 illustrates an example of an HMM used for speech recognition;

FIGS. 6A and 6B illustrate examples of an HMM to which sparse constraint is applied;

FIG. 7 is a schematic illustration of an example of a search process of a route performed by an action estimating unit;

FIG. 8 is a flowchart of a user activity model training process;

FIG. 9 is a flowchart of an estimation process of a travel time;

FIG. 10 is a block diagram illustrating an exemplary configuration of an estimation system according to a second embodiment of the present invention;

FIG. 11 is a block diagram illustrating a first example of the configuration of an action learning unit shown in FIG. 10;

FIG. 12 is a block diagram illustrating a second example of the configuration of an action learning unit shown in FIG. 10;

FIG. 13 is a block diagram of a first example of the configuration of a learner corresponding to an action state recognition sub-unit shown in FIG. 11;

FIG. 14 illustrates an example of the categories of an action state;

FIG. 15 illustrates an example of the time-series moving speed data supplied to an action state labeling unit shown in FIG. 13;

FIG. 16 illustrates an example of the time-series moving speed data supplied to an action state labeling unit shown in FIG. 13;

FIG. 17 is a block diagram of an exemplary configuration of the action state learning unit shown in FIG. 13;

FIGS. 18A to 18D illustrate the results of learning performed by the action state learning unit shown in FIG. 13;

FIG. 19 is a block diagram of an action state recognition sub-unit corresponding to the action state recognition sub-unit shown in FIG. 13;

FIG. 20 is a block diagram of a second example of the configuration of a learner corresponding to an action state recognition sub-unit shown in FIG. 11;

FIG. 21 illustrates exemplary processing performed by an action state labeling unit;

FIG. 22 illustrates an example of the result of learning performed by an action state learning unit shown in FIG. 20;

FIG. 23 is a block diagram illustrating an exemplary configuration of an action state recognition sub-unit corresponding to the action state learning unit shown in FIG. 20;

FIG. 24 is a flowchart of a process of estimating a travel time to a destination;

FIG. 25 is a continuation of the flowchart shown in FIG. 24;

FIG. 26 illustrates the result of processing performed by the estimation system shown in FIG. 10;

FIG. 27 illustrates the result of processing performed by the estimation system shown in FIG. 10;

FIG. 28 illustrates the result of processing performed by the estimation system shown in FIG. 10;

FIG. 29 illustrates the result of processing performed by the estimation system shown in FIG. 10; and

FIG. 30 is a block diagram of an exemplary configuration of a computer according to an embodiment of the present invention.

### DESCRIPTION OF THE PREFERRED EMBODIMENTS

Embodiments of the present invention are described below. Note that descriptions are made in the following order:

1. First Embodiment (Case in Which Route and Travel time Are Estimated When Destination Is Specified)

2. Second Embodiment (Case in Which Route and Travel time Are Estimated after Destination Is Estimated)

### 1. First Embodiment

### Block Diagram of Estimation System According to First Embodiment

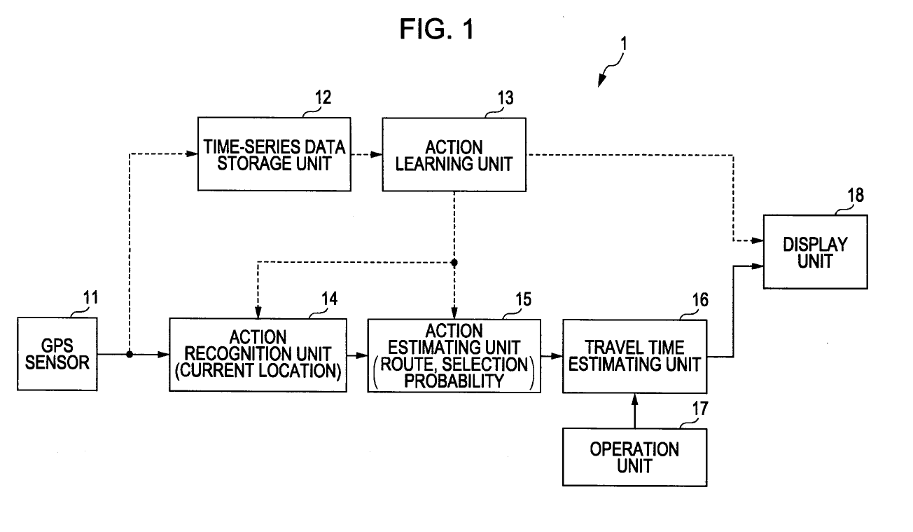

FIG. 1 is a block diagram illustrating an exemplary configuration of an estimation system according to a first embodiment of the present invention.

An estimation system 1 includes a global positioning system (GPS) sensor 11, a time-series data storage unit 12, an action learning unit 13, an action recognition unit 14, an action estimating unit 15, a travel time estimating unit 16, an operation unit 17, and a display unit 18.

The estimation system 1 performs a learning process in which the estimation system 1 trains a probabilistic state transition model representing the activity states (the state representing the action and activity pattern) of a user using time-series data items representing the locations of the user acquired by the GPS sensor 11. In addition, the estimation system 1 performs an estimation process in which a route to a destination specified by the user and a period of time necessary for the user to reach the destination are estimated.

In FIG. 1, the dotted arrow represents the flow of data in the learning process, and the solid arrow represents the flow of data in the estimation process.

The GPS sensor 11 sequentially acquires the latitude and longitude of the GPS sensor 11 itself at predetermined time intervals (e.g., every 15 seconds). However, in some cases, it is difficult for the GPS sensor 11 to acquire the location data at predetermined time intervals. For example, when the GPS sensor 11 is located in a tunnel or underground, it is difficult for the GPS sensor 11 to capture the signal transmitted from an artificial satellite. Thus, the time interval may be increased. In such a case, the necessary data can be acquired by performing an interpolation process.

In the learning process, the GPS sensor 11 supplies the location data (the latitude and longitude data) to the time-series data storage unit 12. However, in the estimation process, the GPS sensor 11 supplies the location data to the action recognition unit 14.

The time-series data storage unit 12 stores the location data items sequentially acquired by the GPS sensor 11 (i.e., time-series location data items). In order to learn the action and activity pattern of the user, time-series location data items for a certain period of time (e.g., for several days) are necessary.

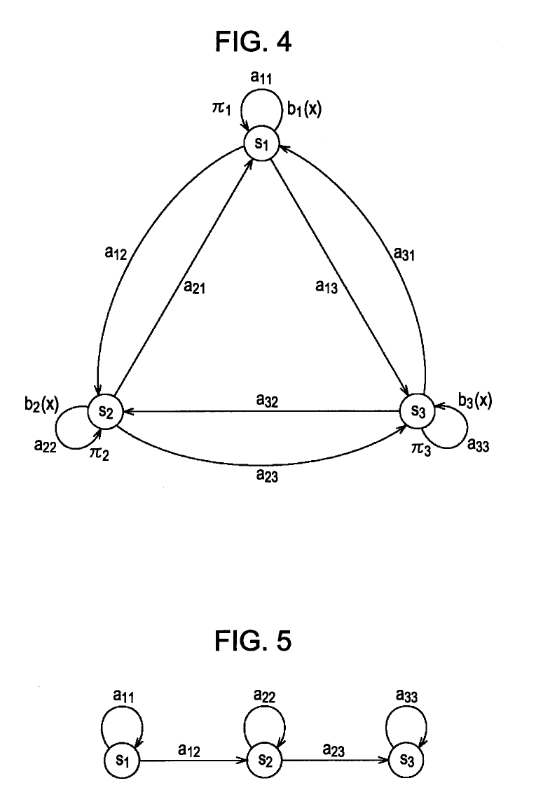

The action learning unit 13 learns the activity states of the user who carries a device including the GPS sensor 11 using the time-series data items stored in the time-series data storage unit 12 and generates a probabilistic state transition model. Since the time-series data items represent the locations of the user, the activity states of the user learned as the probabilistic state transition model represent the states indicating time-series changes in the current location of the user (i.e., the route of the moving user). For example, a probabilistic state transition model including a hidden state, such as an ergodic hidden markov model (HMM), can be used as the probabilistic state transition model used for the learning. According to the present embodiment, an ergodic HMM with a sparse constraint is used as the probabilistic state transition model. Note that the ergodic HMM with a sparse constraint and a method for computing the parameters of the ergodic HMM are described below with reference to FIGS. 4 and 5 and FIGS. 6A and 6B.

The action learning unit 13 supplies data representing the result of learning to the display unit 18, which displays the result of learning. In addition, the action learning unit 13 supplies the parameters of the probabilistic state transition model obtained through the learning process to the action recognition unit 14 and the action estimating unit 15.

Using the probabilistic state transition model with the parameters obtained through the learning, the action recognition unit 14 recognizes the current activity state of the user from the time-series location data items supplied from the GPS sensor 11 in real time. That is, the action recognition unit 14 recognizes the current location of the user. Thereafter, the action recognition unit 14 supplies the node number of a current state node of the user to the action estimating unit 15.

Using the probabilistic state transition model with the parameter obtained through the learning, the action estimating unit 15 searches for (or estimates) possible routes starting from the current location of the user indicated by the node number of the state node supplied from the action recognition unit 14 for the user without excess and shortage. In addition, the action estimating unit 15 estimates a selection probability representing a probability of the found route being selected by computing the occurrence probability for each of the found routes.

The travel time estimating unit 16 receives, from the action estimating unit 15, the possible routes for the user to select and the selection probabilities thereof. In addition, the travel time estimating unit 16 receives, from the operation unit 17, information regarding the destination specified by the user.

The travel time estimating unit 16 extracts, from among the routes that the user can select, the routes including the destination specified by the user. Thereafter, the travel time estimating unit 16 estimates the travel time to the destination for each of the routes. In addition, the travel time estimating unit 16 estimates the arrival probability of the user arriving at the destination. If a plurality of routes that allow the user to reach the destination are found, the travel time estimating unit 16 computes the sum of the selection probabilities of the routes and considers the sum as the arrival probability for the destination. If the number of routes to the destination is one, the selection probability of the route is the same as the arrival probability at the destination. Thereafter, the travel time estimating unit 16 supplies information representing the result of the estimation to the display unit 18, which displays the result of the estimation.

The operation unit 17 receives information regarding the destination input from the user and supplies the information to the travel time estimating unit 16. The display unit 18 displays the information supplied from the action learning unit 13 or the travel time estimating unit 16.

### Exemplary Hardware Configuration of Estimation System

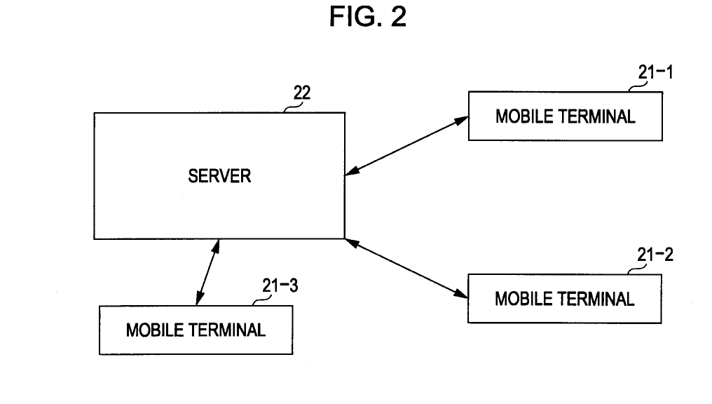

The above-described estimation system 1 can have the hardware configuration shown in FIG. 2, for example. That is, FIG. 2 is a block diagram illustrating an exemplary hardware configuration of the estimation system 1.

As shown in FIG. 2, the estimation system 1 includes three mobile terminals 21-1 to 21-3 and a server 22. The mobile terminals 21-1 to 21-3 have the same function and are collectively referred to as “mobile terminals 21”. However, different users have the mobile terminals 21-1 to 21-3. Accordingly, although, in FIG. 2, only the three mobile terminals 21-1 to 21-3 are shown, a number of mobile terminals 21 equal to the number of users, in reality, are present in FIG. 2.

The mobile terminal 21 can exchange data with the server 22 via wireless communication and communication using a network, such as the Internet. The server 22 receives data transmitted from the mobile terminal 21 and performs predetermined processing on the received data. Thereafter, the server 22 transmits the result of the data processing to the mobile terminal 21.

Accordingly, each of the mobile terminal 21 and the server 22 has at least a communication unit having a wireless or wired communication capability.

In addition, the mobile terminal 21 can include the GPS sensor 11, the operation unit 17, and the display unit 18 shown in FIG. 1. The server 22 can include the time-series data storage unit 12, the action learning unit 13, the action recognition unit 14, the action estimating unit 15, and the travel time estimating unit 16 shown in FIG. 1.

In such a configuration, the mobile terminal 21 transmits time-series data items acquired by the GPS sensor 11 during a learning process. The server 22 learns the activity states using a probabilistic state transition model and the received learning time-series data items. Thereafter, in the estimation process, the mobile terminal 21 transmits the information regarding the destination specified by the user through the operation unit 17. In addition, the mobile terminal 21 transmits the location data acquired by the GPS sensor 11 in real time. The server 22 recognizes the current activity state of the user (i.e., the current location of the user) using parameters obtained through the learning process. Furthermore, the server 22 transmits the result of processing (i.e., the route to the specified destination and the period of time necessary for the user to reach the destination) to the mobile terminal 21. The mobile terminal 21 displays the result of processing transmitted from the server 22 on the display unit 18.

Alternatively, for example, the mobile terminal 21 may include the GPS sensor 11, the action recognition unit 14, the action estimating unit 15, the travel time estimating unit 16, the operation unit 17, and the display unit 18 shown in FIG. 1. The server 22 may include the time-series data storage unit 12 and the action learning unit 13 shown in FIG. 1.

In such a configuration, the mobile terminal 21 transmits time-series data items acquired by the GPS sensor 11 during a learning process. The server 22 learns the activity states using a probabilistic state transition model and the received learning time-series data items. Thereafter, the mobile terminal 21 transmits parameters obtained though the learning process. In the estimation process, the mobile terminal 21 recognizes the current location of the user using location data acquired by the GPS sensor 11 in real time and the parameters received from the server 22. In addition, the mobile terminal 21 computes the route to the specified destination and the period of time necessary for the user to reach the destination. Thereafter, the mobile terminal 21 displays the result of computation (i.e., the route to the specified destination and the period of time necessary for the user to reach the destination) on the display unit 18.

The above-described roles of the mobile terminal 21 and the server 22 can be determined in accordance with the data processing power of each of the mobile terminal 21 and the server 22 and a communication environment.

The elapsed time of a learning process is significantly long. However, the learning process is not significantly frequently performed. Accordingly, since, in general, the server 22 has more processing power than the mobile terminal 21, the server 22 can perform the learning process (updating of the parameters) using accumulated time-series data items about once a day.

In contrast, since it is desirable that the estimation process be performed at high speed in accordance with the location data frequently updated in real time and the result be displayed, the estimation process is performed by the mobile terminal 21. If the communication environment is rich, it is desirable that, as described above, the server 22 also perform the estimation process and the mobile terminal 21 receives only the result of the estimation process from the server 22, since the load imposed on the mobile terminal 21 that is compact for carrying can be reduced.

However, when the mobile terminal 21 alone can perform data processing, such as the learning process and the estimation process, at high speed, the mobile terminal 21 may include all of the components shown in FIG. 1.

### Example of Input Time-Series Data Items

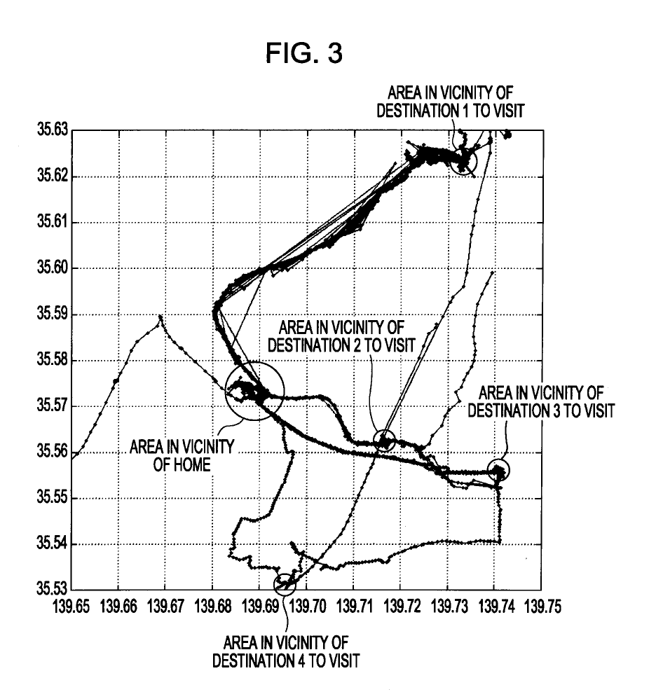

FIG. 3 illustrates an example of time-series location data items acquired by the estimation system 1. In FIG. 3, the abscissa represents the longitude, and the ordinate represents the latitude.

The time-series data items shown in FIG. 3 are obtained from an experimenter over a period of about one month and a half. As shown in FIG. 3, the time-series data items include location data regarding the vicinity of the home and location data regarding four destinations that the experimenter goes to (e.g., the office). Note that the time-series data items include data items without location information, since the signal from an artificial satellite is not received.

The time-series data items shown in FIG. 3 are used as training data items in an experiment described below.

### Ergodic HMM

An ergodic HMM used as a learning model in the estimation system 1 is described next.

FIG. 4 illustrates an example of an HMM.

An HMM is a state transition model having states and transition between the states.

A three-state HMM is shown in FIG. 4.

In FIG. 4 (and the subsequent drawings), a circle represents a state. An arrow represents a state transition. Note that the state corresponds to the above-described activity state of the user. Note that the term “state” is synonymous with the term “state node”.

In addition, in FIG. 4, sᵢ (i=1, 2, 3 in FIG. 4) represents a state (a node). aᵢⱼ represents the state transition probability from a state si to a state sⱼ. In addition, bⱼ(x) represents the output probability density function indicating the probability of observing an observation value x when a state transition to a state Sⱼ occurs. πᵢ represents an initial probability of the state Sᵢ being an initial state.

Note that, for example, a mixed normal probability distribution is used as the output probability density function bⱼ(x).

The HMM (the continuous HMM) is defined using the state transition probability aᵢⱼ, the output probability density function bⱼ(x), and the initial probability πᵢ. The state transition probability aᵢⱼ, the output probability density function bⱼ(x), and the initial probability πᵢ are referred to as “HMM parameter λ={aᵢⱼ, bⱼ(x), πᵢ, i=1, 2, . . . M, j=1, 2, . . . M}”. M represents the number of states of the HMM.

In order to estimate the parameter λ, Baum-Welch maximum likelihood estimation is widely used. The Baum-Welch maximum likelihood estimation is one example of estimation methods of estimating parameters based on an Expectation-Maximization (EM) algorithm.

According to the Baum-Welch maximum likelihood estimation, the parameter λ of the HMM is estimated on the basis of observation time-series data items x=x₁, x₂, . . . x_{T} so that the likelihood obtained from an occurrence probability representing a probability of the time-series data items being observed (the occurrence of the time-series data items) is maximized. Here, xₜ represents a signal (a sample value) observed at a time t. T represents the length of the time-series data items (the number of samples).

Baum-Welch maximum likelihood estimation is described in, for example, “Pattern Recognition and Machine Learning (Information Science and Statistics)”, Christopher M. Bishop, Springer, New York, 2006.

Note that Baum-Welch maximum likelihood estimation is a method for estimating a parameter on the basis of maximizing the likelihood. However, optimality is not ensured. The parameter may converge to only the local solution in accordance with the structure of the HMM and the initial value of the parameter λ.

HMMs are widely used for speech recognition. However, in general, in HMMs used for speech recognition, the number of the states and a way how state transition occurs are determined in advance.

FIG. 5 illustrates an example of an HMM used for speech recognition.

The HMM shown in FIG. 5 is referred to as a “left-to-right HMM”.

In FIG. 5, the number of states is 3, and the state transition is constrained to be limited to only a self-transition (a transition from a state sᵢ to the state sᵢ) and a state transition from the left state to the neighboring right state.

In contrast to the HMM having a constraint in terms of state transition shown in FIG. 5, an HMM having no constraint in terms of state transition shown in FIG. 4 (i.e., an HMM that allows a transition from any state sᵢ to any state sⱼ) is referred to as an “ergodic HMM”.

An ergodic HMM is an HMM having the highest degree of freedom. However, if the number of states increases, estimation of the parameter λ becomes difficult.

For example, if the number of states of an ergodic HMM is 1000, the ergodic HMM has one million (=1000×1000) state transitions.

Accordingly, in such a case, it is necessary to estimate, for example, one million state transition probabilities aᵢⱼ of the parameter λ.

Thus, for example, a constraint indicating that the state transition has a sparse structure (a sparse constraint) can be applied to the state transition set for a state.

As used herein, the term “sparse structure” refers to a structure in which a condition for allowing a transition from a certain state is significantly limited, unlike the dense state transition, such as that is an ergodic HMM, in which a transition from any state to any state is allowed.

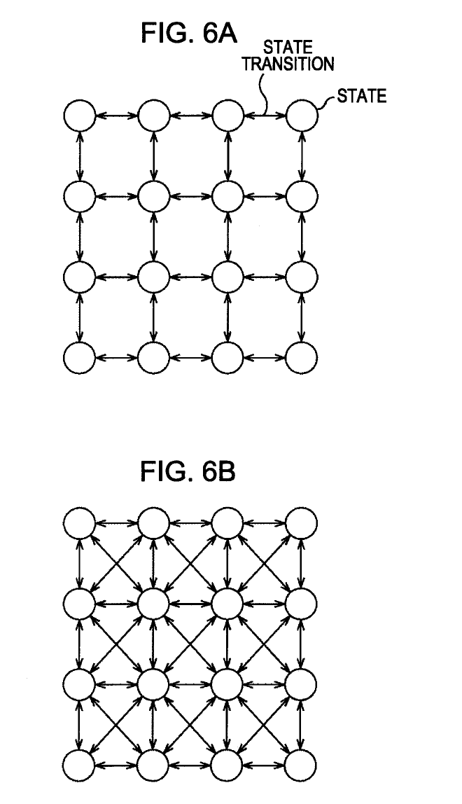

FIGS. 6A and 6B illustrate HMMs to which sparse constraint is applied.

In FIGS. 6A and 6B, a two-headed arrow between two states represents a transition from one of the states to the other state and vice versa. In addition, in FIGS. 6A and 6B, each of the states can have self-transition, although an arrow that indicates self-transition is not shown in FIGS. 6A and 6B.

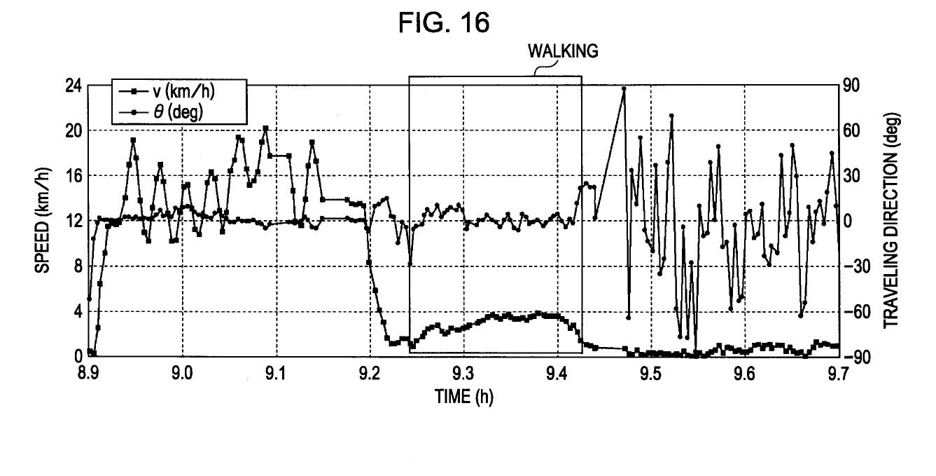

In FIGS. 16A and 16B, sixteen states are arranged in a two-dimensional space in a lattice. That is, in FIGS. 16A and 16B, four states are arranged in the transverse direction, and four states are arranged in the longitudinal direction.

Let a distance between neighboring states in the transverse direction be 1, and a distance between neighboring states in the longitudinal direction be 1. Then, FIG. 6A illustrates an HMM to which a sparse constraint indicating that a state transition with a distance of 1 or less is allowed and other state transitions are not allowed is applied.

FIG. 6B illustrates an HMM to which a sparse constraint indicating that a state transition with a distance of √2 or less is allowed and other state transitions are not allowed is applied.

According to the present embodiment, the location data acquired by the GPS sensor 11 is time-series data x=x₁, x₂ . . . , x_{T}, which is supplied to the time-series data storage unit 12. The action learning unit 13 estimates the parameter λ of an HMM serving as a user activity model using the time-series data x=x₁, x₂ . . . , x_{T} stored in the time-series data storage unit 12.

That is, the location data items (pairs consisting of the latitude and longitude) at a plurality of points in time indicating the movement trajectory of the user are considered as observation data items of a probability variable having a normal distribution with a width of a predetermined variance value from a certain point in a map that corresponds to any one of the states sⱼ of the HMM. The action learning unit 13 optimizes the point in the map corresponding to each of the states sⱼ and the variance value and the state transition probability aᵢⱼ of that point.

Note that the initial values πᵢ of the states sᵢ can be set to the same value. For example, the initial probabilities πᵢ of the M states sᵢ are set to 1/M. Alternatively, location data obtained by performing predetermined processing, such as an interpolation process, on the location data items acquired by the GPS sensor 11 may be considered as the time-series data x=x₁, x₂ . . . , x_{T}. Thereafter, the time-series data x=x₁, x₂ . . . , x_{T} may be supplied to the time-series data storage unit 12.

The action recognition unit 14 applies a Viterbi algorithm to the user activity model (the HMM) obtained through the learning and obtains the sequence (the state sequence) or a path of the state transition that maximizes the likelihood of the location data x=x₁, x₂ . . . , x_{T}. received by the GPS sensor 11 being observed (hereinafter, that path is also referred to as a “maximum likelihood path”. In this way, the current activity state of the user (i.e., the state sᵢ corresponding to the current location of the user) can be recognized.

The Viterbi algorithm is used to determine a path (a maximum likelihood path) that maximizes the occurrence probability, that is, the value obtained by accumulating the state transition probability aᵢⱼ representing the probability of state transition from a state sᵢ to a state sⱼ at a time t in the state transition paths starting from each of the states si and the probability of a sample value xₜ at the time t among the location data items x=x₁, x₂ . . . , x_{T} being observed in the state transition along the length T of the time-series data x. The Viterbi algorithm is described in more detail in the above-described document “Pattern Recognition and Machine Learning (Information Science and Statistics)”.

### Search Process of Path Performed by Action Estimating Unit

An exemplary search process of a path performed by the action estimating unit 15 is described next.

The states sᵢ obtained through the learning represent certain points (location) in the map. If the state sᵢ is connected to the state sⱼ, the presence of a path from the state sᵢ to the state sⱼ is indicated.

In such a case, a point corresponding to each of the states sᵢ can be categorized into one of the following: an end point, a pass point, a branch point, and a loop. The term “end point” refers to a point having a significantly low transition probability other than self-transition (i.e., the probability other than self-transition is lower than or equal to a predetermined value) and, therefore, having no next point that can be reached from the point. The term “pass point” refers to a point having only one transition other than self-transition, that is, a point having the one next point which can be reached from the point. The term “branch point” refers to a point having two transitions other than self-transition, that is, a point having two next points that can be reached from the point. The term “loop” refers to a point that is the same as any one of the points in already passed routes.

When a route to the destination is searched for and if a plurality of different routes exist, it is desirable that information regarding each of the routes (e.g., a necessary period of time for the user to reach the destination) be displayed. Accordingly, in order to search for possible routes without excess and shortage, the following conditions are set:

(1) Even when a route is branched and merged again, the route is considered as a different route.

(2) If an end point or a point included in already passed routes appears in the route, the search for the route is completed.

First, the action estimating unit 15 classifies the next possible point of the current activity state of the user recognized by the action recognition unit 14 (i.e., the current location of the user) into one of an end point, a pass point, a branch point, and a loop. Subsequently, the action estimating unit 15 repeats this operation until the above-described end condition (2) is satisfied.

If the current point is classified as an end point, the action estimating unit 15 connects the current point to the route up to this point and completes the search for the route.

However, if the current point is classified as a pass point, the action estimating unit 15 connects the current point to the route up to this point and moves the focus to the next point.

If the current point is classified as a branch point, the action estimating unit 15 links the current point to the route traveled in the past and copies the route traveled in the past a number of times equal to the number of branches and links the copied routes to the branch point. Thereafter, the action estimating unit 15 moves the focus to one of the branch destinations and considers the branch destination as the next point.

If the current point is classified as a loop, the action estimating unit 15 does not link the current point to the route traveled in the past and completes the route search operation. Note that since the case in which the action estimating unit 15 moves back the focus from the current point to the immediately previous point is included in the case of a loop, this case is not discussed.

### Example of Search Process

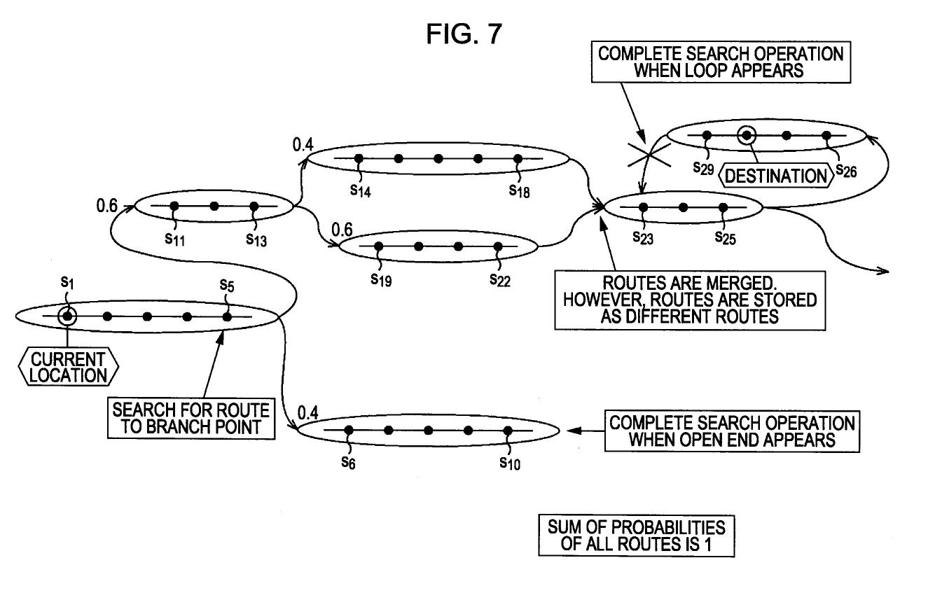

FIG. 7 is a schematic illustration of an example of a search process of a route performed by the action estimating unit 15.

In the example shown in FIG. 7, if the state s₁ represents the current location, three routes are finally found. A first route is a route from the state s₁ to a state s₁₀ via states s₅ and s₆ (hereinafter referred to as a “route A”). A second route is a route from the state s₁ to the state s₂₉ via the states s₅, s₁₁, s₁₄, and s₂₃ (hereinafter referred to as a “route B”). A third route is a route from the state s₁ to the state s₂₉ via the states s₅, s₁₁, s₁₉, and s₂₃ (hereinafter referred to as a “route C”).

The action estimating unit 15 computes the probability of each of the found routes being selected. The selection probability of each of the routes can be computed by sequentially multiplying the transition probability between the states of the route. However, only the transition from a certain state to the next state is taken into account, and it is not necessary to take into account the case in which the user remains stationary at the same location. Accordingly, the selection probability can be computed using a transition probability [aᵢⱼ] that is obtained by excluding the self-transition probability from the state transition probability aᵢⱼ of each of the states obtained through learning and normalizing the state transition probability aᵢⱼ.

The transition probability [aᵢⱼ] obtained by excluding the self-transition probability from the state transition probability aᵢⱼ of each of the states obtained through learning and normalizing the state transition probability aᵢⱼ can be expressed as follows:

$$[ {a}_{ij} ] = \frac{( 1 - {δ}_{ij} ) {a}_{ij}}{{\sum }_{j = 1}^{N} ( 1 - {δ}_{ij} ) {a}_{ij}} \qquad ( 1 )$$

where δ represents the Kronecker function that returns “1” if the subscript i is the same as the subscript j and returns “0” otherwise.

Accordingly, in terms of, for example, the state transition probability aᵢⱼ of the state s₅ shown in FIG. 7, let the self-transition probability a_{5, 5}=0.5, the transition probability a_{5, 6}=0.2, and the transition probability a_{5, 11}=0.3. Then, when the state s₅ is branched to the state s₆ or state s₁₁, the transition probability [a_{5, 6}] is 0.4 and the transition probability [a_{5, 11}] is 0.6.

Let the node number i of the state sᵢ in the found route be (y₁, y₂, . . . , yₙ). Then, using the normalized transition probability [aᵢⱼ], the selection probability of the route can be expressed as follows:

$$\begin{matrix}P ( {y}_{1} , {y}_{2} , … , {y}_{n} ) = [ {a}_{{y}_{1} {y}_{2}} ] [ {a}_{{y}_{2} {y}_{3}} ] … [ {a}_{{y}_{n - 1} {y}_{n}} ] \\ = {\prod }_{i = 1}^{n - 1} [ {a}_{{y}_{i - 1} {y}_{i}} ]\end{matrix} \qquad ( 2 )$$

In practice, the normalized transition probability [aᵢⱼ] at a pass point is 1. Accordingly, the selection probability can be computed by sequentially multiplying only the normalized transition probabilities [aᵢⱼ] at the branches.

In the example shown in FIG. 7, the selection probability of the route A is 0.4. The selection probability of the route B is 0.24 (=0.6×0.4). The selection probability of the route C is 0.36 (=0.6×0.6). Accordingly, the sum of the computed selection probabilities of the routes is 1 (=0.4+0.24+0.36). Thus, it can be seen that search without excess and shortage can be performed.

In this way, the routes searched for in accordance with the current location and the selection probabilities of the routes are supplied from the action estimating unit 15 to the travel time estimating unit 16.

The travel time estimating unit 16 extracts the routes including the destination specified by the user from among the routes found by the action estimating unit 15. Thereafter, the travel time estimating unit 16 estimates a travel time to the destination for each of the extracted routes.

For example, in FIG. 7, among the three found routes A to C, the routes B and C include the state s₂₈, which is the destination. The travel time estimating unit 16 estimates a travel time to the destination state s₂₈ via the route B or C.

Note that when a large number of routes are found and if it is difficult for the user to see all of the displayed routes or the number of displayed routes is limited to a predetermined number, it is necessary for the user to select the routes to be displayed on the display unit 18 from among all of the routes including the destination. In such a case, since the selection probability of every route has already been computed by the action estimating unit 15, the travel time estimating unit 16 can select a predetermined number of routes to be displayed in order from the route having the highest selection probability to the lowest.

Let a state s_{y1} denote the current location at a current time t₁. Let (s_{y1}, s_{y2}, . . . , s_{yg}) denote the routes determined at the times (t₁, t₂, . . . , t_{g}). That is, the node numbers i of the states si in the determined route is (y₁, y₂, . . . , y_{g}). Hereinafter, for simplicity, the state sᵢ corresponding to the location is also represented by the node number i.

Since the current location y₁ at a current time t₁ is determined through the recognition process performed by the action recognition unit 14, a probability P_{y1}(t₁) of the current location at the time t₁ being y₁ is:

P_{y1}(t₁)=1.

In addition, the probability of the location at the current time t₁ being a location other than the location y₁ is 0.

A probability Pyₙ(tₙ) of the location at a given time tₙ being the node having the node number yₙ can be expressed as follows:

P_{y}_{ₙ}(tₙ)=P_{y}_{ₙ}(tₙ−1)A_{y}_{ₙ}_{y}_{ₙ}+P_{y}_{_{n−1}}(tₙ−1)A_{y}_{_{n−1}}_{y}_{ₙ} (3)

The first term of the right-hand side of equation (3) represents a probability of self-transition when the original location is yₙ. The second term represents a probability of the transition from the immediately previous location yₙ₋₁ to the location yₙ. Unlike computation of the selection probability of a route, the state transition probability aᵢⱼ obtained through learning is directly used in equation (3).

Using the probability that the user is located at the location y_{g-1} which is a location immediately before the destination y_{g} at a time t_{g-1} which is a time immediately prior to the time t_{g} and the user moves to the destination y_{g} at the time t_{g}, an estimation value <t_{g}> of an arrival time t_{g} at the destination y_{g} can be expressed as follows:

$$〈 {t}_{g} 〉 = {\sum }_{t} {t}_{g} ( \frac{{P}_{{x}_{g - 1}} ( {t}_{g - 1} - 1 ) {A}_{{x}_{g - 1} {x}_{g}}}{{\sum }_{t} {P}_{{x}_{g - 1}} ( {t}_{g} - 1 ) {A}_{{x}_{g - 1} {x}_{g}}} ) \qquad ( 4 )$$

That is, the estimation value <t_{g}> is represented as an expected value of a period of time from the current time to a time when the user is located in a state s_{yg-1} which is a state immediately before a state s_{yg} at a time t_{g-1} which is a time immediately prior to the current time and the user moves to the state s_{yg} at the time t_{g}.

In order to obtain the estimation value of an arrival time at the destination using the method described in Japanese Patent Application No. 2009-180780, it is necessary to integrate the state transition probability aᵢⱼ of the state corresponding to the destination after a “predetermined period of time” has elapsed with respect to the time t. In this case, it is difficult to determine how long the time used for the integration is. In the method described in Japanese Patent Application No. 2009-180780, it is difficult to recognize the case in which the user reaches the destination via a loop. Accordingly, when a loop exists in the route to the destination and if the integration interval is set to a long interval, the case of second and third arrivals to the destination via the loop is included. Thus, it is difficult to correctly compute the travel time to the destination.

Similarly, in the computation of the arrival time at the destination using equation (4) according to the present embodiment, it is necessary to perform integration (Σ) with respect to a time t. However, the case in which a user reaches the destination via a route including a loop is excluded. Accordingly, a sufficiently long integration interval for computing the expected value can be set. The integration interval in equation (4) can be set to, for example, a time that is the same as or twice the maximum travel time among the travel times necessary for the learned routes.

### Training Process of User Activity Model

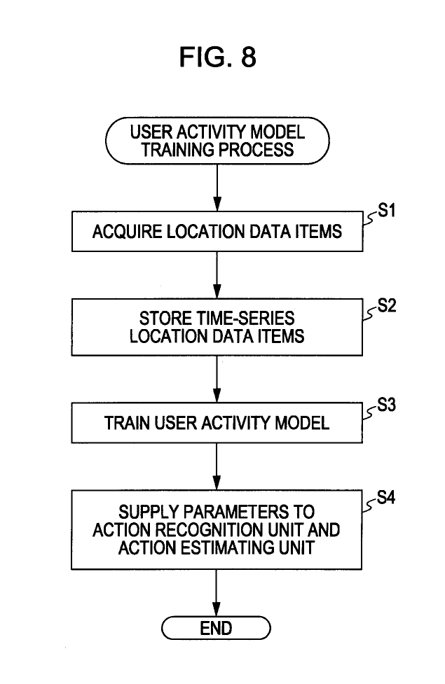

A user activity model training process in which a probabilistic state transition model representing the activity states of the user is trained to learn a route of travel of the user is described next with reference to FIG. 8.

First, in step S1, the GPS sensor 11 acquires location data items and supplies the location data items to the time-series data storage unit 12.

In step S2, the time-series data storage unit 12 stores the location data items continuously acquired by the GPS sensor 11, that is, the time-series location data items.

In step S3, the action learning unit 13 trains the user activity model in the form of a probabilistic state transition model using the time-series location data items stored in the time-series data storage unit 12. That is, the action learning unit 13 computes the parameters of the probabilistic state transition model (the user activity model) using the time-series location data items stored in the time-series data storage unit 12.

In step S4, the action learning unit 13 supplies the parameters of the probabilistic state transition model computed in step S3 to the action recognition unit 14 and the action estimating unit 15. Thereafter, the process is completed.

### Estimation Process of Travel Time

An estimation process of a travel time is described next. In the estimation process, the routes to the destination are searched for using the parameters of the probabilistic state transition model representing the user activity model obtained through the user activity model learning process shown in FIG. 8, and the travel times necessary for the routes are represented to the user.

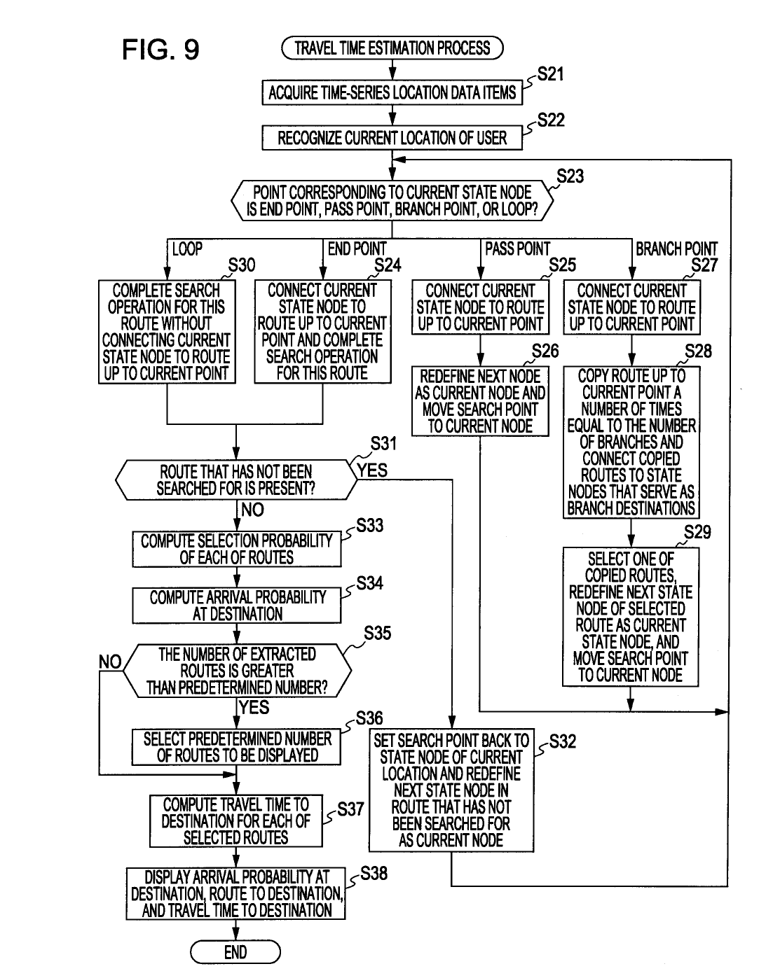

FIG. 9 is a flowchart of the estimation process of the travel time. Note that, in this example, the destination is determined in advance before the process shown in FIG. 9 is performed. However, the destination may be input during the process shown in FIG. 9.

First, in step S21, the GPS sensor 11 acquires time-series location data items and supplies the acquired time-series location data items to the action recognition unit 14. A predetermined number of sampled time-series location data items are temporarily stored in the action recognition unit 14.

In step S22, the action recognition unit 14 recognizes the current activity state of the user using the user activity model based on the parameters obtained through the learning process. That is, the action recognition unit 14 recognizes the current location of the user. Thereafter, the action recognition unit 14 supplies, to the action estimating unit 15, the node number of the current state node of the user.

In step S23, the action estimating unit 15 determines whether a point corresponding to the state node that is currently searched for (hereinafter also referred to as a “current state node”) is an end point, a pass point, a branch point, or a loop. Immediately after the process in step S22 has been performed, the state mode corresponding to the current location of the user serves as the current state node.

If, in step S23, the point corresponding to the current state node is an end point, the processing proceeds to step S24, where the action estimating unit 15 connects the current state node to the route up to the current point. Thereafter, the search for this route is completed and the processing proceeds to step S31. Note that if the current state node is the state node corresponding to the current location, the route up to the current position is not present. Accordingly, the connecting operation is not performed. This also applies to steps S25, S27, and S30.

However, if, in step S23, the point corresponding to the current state node is a pass point, the processing proceeds to step S25, where the action estimating unit 15 connects the current state node to the route up to the current position. Thereafter, in step S26, the action estimating unit 15 redefines the next state node as the current state node and moves the focus to that state node. After the process in step S26 has been completed, the processing returns to step S23.

If, in step S23, the point corresponding to the current state node is a branch point, the processing proceeds to step S27, where the action estimating unit 15 connects the current state node to the route up to the current position. Thereafter, in step S28, the action estimating unit 15 copies the route up to the current point a number of times equal to the number of the branches and connects the copied routes to the state nodes that serve as the branch destinations. In addition, in step S29, the action estimating unit 15 selects one of the copied routes and redefines the next state node of the selected route as the current state node. Thereafter, the action estimating unit 15 moves the focus to that mode. After the process in step S29 has been completed, the processing returns to step S23.

However, if, in step S23, the point corresponding to the current state node is a loop, the processing proceeds to step S30, where the action estimating unit 15 completes the search for this route without connecting the current state node to the route up to the current point. Thereafter, the processing proceeds to step S31.

In step S31, the action estimating unit 15 determines whether a route that has not been searched for is present. If, in step S31, a route that has not been searched for is present, the processing proceeds to step S32, where the action estimating unit 15 returns the focus to the state node of the current location and redefines the next state node in the route that has not been searched for as the current node. After the process in step S32 has been completed, the processing returns to step S23. In this way, for the route that has not been searched for, a search process is performed until an end point or a loop appears.

However, if, in step S31, a route that has not been searched for is not present, the processing proceeds to step S33, where the action estimating unit 15 computes the selection probability (the occurrence probability) of each of the searched routes. The action estimating unit 15 supplies the routes and the selection probability thereof to the travel time estimating unit 16.

In step S34, the travel time estimating unit 16 extracts, from among the routes found by the action estimating unit 15, the routes including the input destination. Thereafter, the travel time estimating unit 16 computes the arrival probability at the destination. More specifically, if a plurality of routes to the destination are present, the travel time estimating unit 16 computes the sum of the selection probabilities of the routes as the arrival probability at the destination. However, if only one route to the destination is present, the travel time estimating unit 16 defines the selection probability of the route as the arrival probability at the destination.

In step S35, the travel time estimating unit 16 determines whether the number of the extracted routes to be displayed is greater than a predetermined number.

If, in step S35, the number of the extracted routes is greater than the predetermined number, the processing proceeds to step S36, where the travel time estimating unit 16 selects a predetermined number of routes to be displayed on the display unit 18. For example, the travel time estimating unit 16 can select the predetermined number of routes in order from the route having the highest selection probability to the lowest.

However, if, in step S35, the number of the extracted routes is less than or equal to the predetermined number, the process in step S36 is skipped. That is, in such a case, all of the routes to the destination are displayed on the display unit 18.

In step S37, the travel time estimating unit 16 computes the travel time to the destination for each of the routes selected to be displayed on the display unit 18. Thereafter, the travel time estimating unit 16 supplies, to the display unit 18, a signal of an image indicating the arrival probability at the destination, the route to the destination, and the period of time necessary for the user to arrive at the destination for each of the routes.

In step S38, the display unit 18 displays the arrival probability at the destination, the route to the destination, and the travel time necessary for the user to arrive at the destination for each of the routes in accordance with the signal of the image supplied from the travel time estimating unit 16. Thereafter, the process is completed.

As described above, in the estimation system 1 according to the first embodiment, a learning process in which the activity state of a user is learned as a probabilistic state transition model using time-series location data items acquired by the GPS sensor 11 is performed. Subsequently, the estimation system 1 estimates the arrival probability at the input destination, the routes to the destination, and the period of time necessary for the user to arrive at the destination via the route using the probabilistic state transition model with the parameters obtained through the learning process. Thereafter, the estimated information is presented to the user.

Accordingly, according to the first embodiment, the estimation system 1 can estimate the arrival probability at the destination specified by the user, the routes to the destination, and the period of time necessary for the user to arrive at the destination and present the estimated information to the user.

### 2. Second Embodiment

### Block Diagram of Estimation System According to Second Embodiment

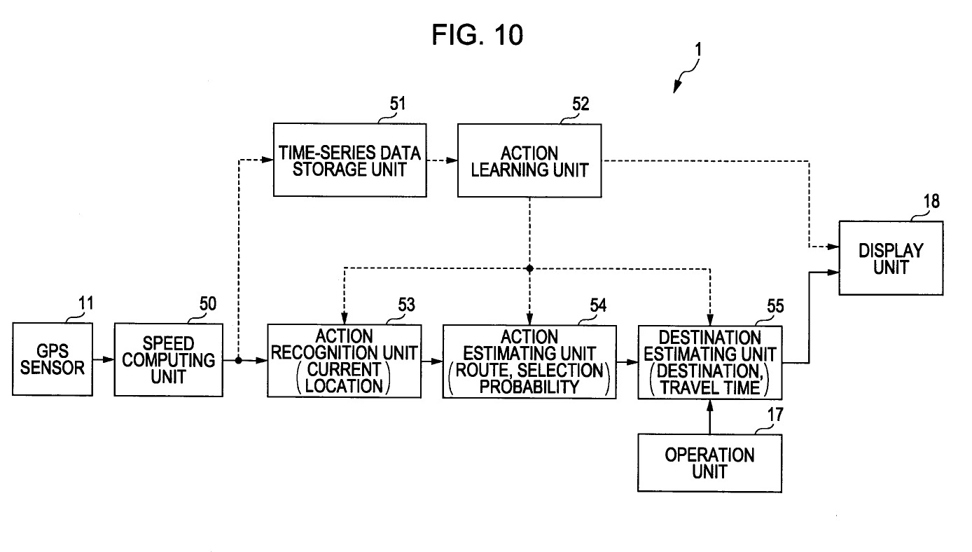

FIG. 10 is a block diagram illustrating an exemplary configuration of an estimation system according to a second embodiment of the present invention. Note that, in FIG. 10, the same reference numerals are used to designate corresponding parts of the first embodiment, and the descriptions thereof are not repeated as appropriate (the same applies the other drawings).

As shown in FIG. 10, an estimation system 1 includes a GPS sensor 11, a speed computing unit 50, a time-series data storage unit 51, an action learning unit 52, an action recognition unit 53, an action estimating unit 54, a destination estimating unit 55, an operation unit 17, and a display unit 18.

In the first embodiment, the destination is specified by a user. However, according to the second embodiment, the estimation system 1 further estimates the destination using the time-series location data items acquired by the GPS sensor 11. The number of destinations may not be one. A plurality of destinations may be estimated. The estimation system 1 computes the arrival probability at the estimated destination, the routes to the destination, and the period of time necessary for the user to arrive at the destination and presents the computed information to the user.

In general, the user remains stationary at the destination, such as a home, an office, a railway station, a shop, or a restaurant, for a certain period of time. Thus, the moving speed of the user is nearly zero. However, if the user is moving to the destination, the moving speed of the user varies in a predetermined pattern determined in accordance with a form of transportation. Accordingly, the action state of the user (i.e., whether the user remains stationary at the destination (a stationary state) or the user is moving (a moving state)) can be recognized using the information regarding the moving speed of the user. Thus, the location corresponding to the stationary state can be estimated as the destination.

The speed computing unit 50 computes the moving speed of the user using the location data items supplied from the GPS sensor 11 at predetermined time intervals.

More specifically, when the position data item obtained in a kth step (i.e., a kth position data item) is represented as a combination of a time tₖ, a longitude yₖ, and a latitude xₖ, a moving speed vxₖ in the x direction and a moving speed vyₖ in the y direction in the kth step can be computed using the following equation:

$${vx}_{k} = \frac{{x}_{k} - {x}_{k - 1}}{{t}_{k} - {t}_{k - 1}} {vy}_{k} = \frac{{y}_{k} - {y}_{k - 1}}{{t}_{k} - {t}_{k - 1}} \qquad ( 5 )$$

In equations (5), the latitude and longitude data acquired from the GPS sensor 11 is directly used. However, a process of converting the latitude and longitude data to a distance and a process of converting the speed per hour or a speed per minute can be performed as necessary.

In addition, using the moving speeds vxₖ and vyₖ obtained using equations (5), the speed computing unit 50 can further compute a moving speed Vₖ and a change θₖ in the traveling direction in the kth step as follows:

$${v}_{k} = \sqrt{{vx}_{k}^{2} + {vy}_{k}^{2}} {θ}_{k} = {sin}^{- 1} ( \frac{{vx}_{k} \cdot {vy}_{k - 1} - {vx}_{k - 1} \cdot {vy}_{k}}{{v}_{k} \cdot {v}_{k - 1}} ) \qquad ( 6 )$$

The feature can be extracted better when the moving speed vₖ and the change θₖ in the traveling direction expressed by equations (6) are used than when the moving speeds vxₖ and vyₖ expressed by equations (5) are used. The reason is as follows:

1) The data distributions of the moving speeds vxₖ and vyₖ are biased with respect to the longitude axis and the latitude axis. Accordingly, even when the same form of transportation (e.g., a train or walking) is used, it may be difficult to identify the distribution if the angle of the traveling direction with respect to the longitude axis or the latitude axis changes. However, if the moving speed vₖ is used, such a problem rarely arises.

2) When learning is performed using only the absolute value |v| of the moving speed, it is difficult to distinguish “walking” from “stationary” due to a value |v| of the noise of a device. By taking into account a change in the traveling direction, the affect of noise can be reduced.

3) When the user is moving, a change in the traveling direction rarely occurs. However, when the user remains stationary, the traveling direction frequently changes. Accordingly, by using a change in the traveling direction, moving of the user is easily distinguished from “stationary” of the user.

For the above-described reason, according to the present embodiment, the speed computing unit 50 computes the moving speed vₖ and the change θₖ in the traveling direction expressed by equations (6) as data of the moving velocity and supplies the computed data to the time-series data storage unit 12 and the action recognition unit 53 together with the location data items.

In addition, in order to remove a noise component, the speed computing unit 50 performs a filtering process (pre-processing) using the moving average before computing the moving speed vₖ and the change θₖ.

Hereinafter, a change θₖ in the traveling direction is simply referred to as a “traveling direction θₖ”.

Some type of the GPS sensor 11 can output the moving speed. If such a type of the GPS sensor 11 is employed, the speed computing unit 50 may be removed, and the moving speed output from the GPS sensor 11 can be directly used.

The time-series data storage unit 51 stores the time-series location data items and the time-series moving speed data items output from the speed computing unit 50.

The action learning unit 52 learns the moving trajectory and action states of the user in the form of a probabilistic state transition model using the time-series data items stored in the time-series data storage unit 51. That is, the action learning unit 52 recognizes the current location of the user and trains a user activity model in the form of a probabilistic state transition model for estimating the destination, the route to the destination, and a travel time to the destination.

The action learning unit 52 supplies the parameters of the probabilistic state transition model obtained through the learning process to the action recognition unit 53, the action estimating unit 54, and the destination estimating unit 55.

The action recognition unit 53 recognizes the current location of the user using the probabilistic state transition model with the parameters obtained through the learning process and the time-series position and the moving speed data items. The action recognition unit 53 supplies the node number of the current state node of the user to the action estimating unit 54.

The action estimating unit 54 searches for the possible routes that the user can take using the probabilistic state transition model with the parameters obtained through the learning process and the current location without excess and shortage and computes the selection probability of each of the found routes.

That is, the action recognition unit 53 and the action estimating unit 54 are similar to the action recognition unit 14 and the action estimating unit 15 of the first embodiment, respectively, except that the action recognition unit 53 and the action estimating unit 54 additionally use the parameters obtained by additionally using the time-series moving speed data items and learning the action states in addition to the traveling route.

The destination estimating unit 55 estimates a destination of the user using the probabilistic state transition model with the parameters obtained through the learning process.

More specifically, the destination estimating unit 55 lists the candidates of destination first. The destination estimating unit 55 selects, as the candidates of destination, the locations at which the recognized action state of the user is a stationary state.

Subsequently, from among the listed candidates of destination, the destination estimating unit 55 selects, as the destinations, the candidates of destination located in the routes found by the action estimating unit 54.

Subsequently, the destination estimating unit 55 computes the arrival probability at each of the selected destinations.

Note that when a large number of routes are found and if all of the routes are displayed on the display unit 18, it may be difficult for the user to see or even a route having a low possibility of the user going to the destination may be displayed. Accordingly, as in the first embodiment that limits the number of found routes, the number of destinations can be also limited so that only a predetermined number of destinations having high arrival probabilities or the destinations having arrival probabilities higher than or equal to a predetermined value are displayed. Note that the number of destinations may differ from the number of routes.

When the destination to be displayed is determined, the destination estimating unit 55 computes a travel time to the destination via the route and instructs the display unit 18 to display the travel time.

Note that, like the first embodiment, when a large number of routes to the destination are found, the destination estimating unit 55 can limit the number of routes to the destination to a predetermined number using the selection probabilities and compute the travel times for the routes to be displayed.

Alternatively, when a large number of routes to the destination are found, the routes to be displayed can be selected in order from the shortest travel time to the longest or in order from the shortest distance to the destination to the longest instead of using the selection probabilities. When the routes to be displayed are selected in order from the shortest travel time to the longest, the destination estimating unit 55, for example, computes the travel times to the destination for all of the routes first and, subsequently, selects the routes to be displayed using the computed travel times. However, when the routes to be displayed are selected in order from the shortest distance to the longest, the destination estimating unit 55, for example, computes the distances to the destination for all of the routes to the destination using the latitude and longitude information corresponding to the state nodes and, subsequently, selects the routes to be displayed using the computed distances.

### First Exemplary Configuration of Action Learning Unit

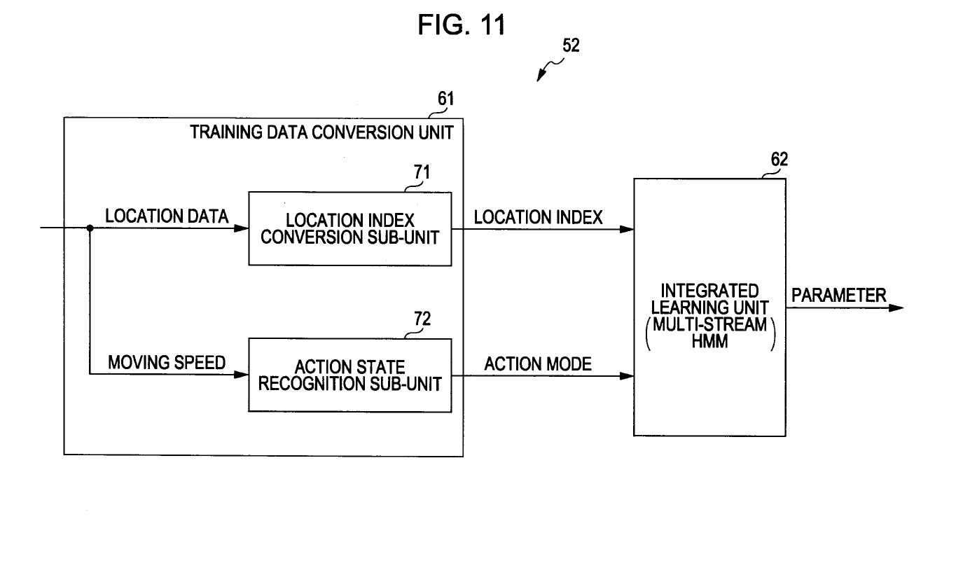

FIG. 11 is a block diagram illustrating a first exemplary configuration of the action learning unit 52 shown in FIG. 10.

The action learning unit 52 learns the movement trajectory and the action state of the user using the time-series location data items and moving speed data items stored in the time-series data storage unit 51 (see FIG. 10).

The action learning unit 52 includes a training data conversion unit 61 and an integrated learning unit 62.

The training data conversion unit 61 includes a location index conversion sub-unit 71 and an action state recognition sub-unit 72. The training data conversion unit 61 converts the position and moving speed data items supplied from the time-series data storage unit 51 to location index and action data items. Thereafter, the training data conversion unit 61 supplies the converted data items to the integrated learning unit 62.

The time-series location data items supplied from the time-series data storage unit 51 are supplied to the location index conversion sub-unit 71. The location index conversion sub-unit 71 can have a configuration that is the same as that of the action recognition unit 14 shown in FIG. 1. That is, the location index conversion sub-unit 71 recognizes the current activity state of the user corresponding to the current location of the user using the user activity model with the parameters obtained through the learning process. Thereafter, the location index conversion sub-unit 71 defines the node number of the current state node of the user as an index indicating the location (a location index) and supplies the location index to the integrated learning unit 62.

For a learner that learns the parameter used by the location index conversion sub-unit 71, the configuration of the action learning unit 13 shown in FIG. 1, which serves as a learner of the action recognition unit 14 shown in FIG. 1, can be employed.

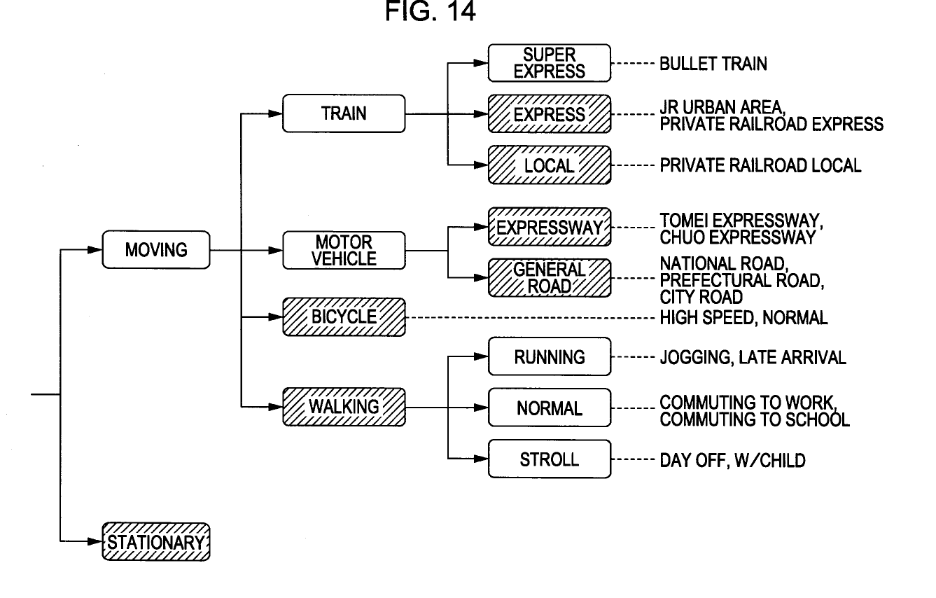

The time-series moving speed data items supplied from the time-series data storage unit 51 are supplied to the action state recognition sub-unit 72. The action state recognition sub-unit 72 recognizes the action state of the user corresponding to the supplied moving speed data items using the parameters of the probabilistic state transition model obtained through learning of the action states of the user. Thereafter, the action state recognition sub-unit 72 supplies the result of recognition to the integrated learning unit 62 in the form of an action mode. It is necessary for the action state of the user recognized by the action state recognition sub-unit 72 to include at least a stationary state and a moving state. According to the present embodiment, as described in more detail below with reference to FIG. 14, the action state recognition sub-unit 72 classifies the moving state into one of the action modes corresponding to the forms of transportation, such as walking, a bicycle, and a motor vehicle. Subsequently, the action state recognition sub-unit 72 supplies the action mode to the integrated learning unit 62.

Accordingly, the integrated learning unit 62 receives time-series discrete data items representing a symbol of a location index and time-series discrete data items representing a symbol of an action mode from the training data conversion unit 61.

The integrated learning unit 62 learns the activity state of the user using the probabilistic state transition model and the time-series discrete data items representing a symbol of a location index and the time-series discrete data items representing a symbol of an action mode. More specifically, the integrated learning unit 62 learns parameters λ of a multi-stream HMM representing the activity state of the user.

A multi-stream HMM is an HMM that outputs data from a state node having a transition probability similar to that of a normal HMM in accordance with a plurality of different probability rules. In a multi-stream HMM, an output probability density function bⱼ(x) among the parameters λ is provided for each type of time-series data.

According to the present embodiment, two types of time-series data (the time-series location index data items and the time-series action mode data items) are used. Therefore, two types of output probability density function bⱼ(x) (i.e., an output probability density function b1ⱼ(x) corresponding to the time-series location index data items and an output probability density function b2ⱼ( )corresponding to the time-series action mode data items) are provided. The output probability density function b1ⱼ(x) indicates the probability of an index in a map being x when the state node of the multi-stream HMM is j. The output probability density function b2ⱼ(x) indicates the probability of an action mode being x when the state node of the multi-stream HMM is j. Accordingly, in a multi-stream HMM, the activity state of the user is learned while associating the index in a map with the action mode (integration learning).

More specifically, the integrated learning unit 62 learns the probability of a location index output from each of the state node (the probability indicating which index is output) and the probability of an action mode output from each of the state node (the probability indicating which action mode is output). By using an integrated model (a multi-stream HMM) obtained through the learning process, a state node that stochastically easily outputs an action mode of a “stationary state” can be obtained. Thereafter, the location index is obtained from the recognized state node. Thus, the location index of a destination candidate can be recognized. Furthermore, the location of the destination can be recognized by using the latitude and longitude distribution indicated by the location indices of the destination candidates.

As described above, it can be estimated that the location indicated by the location index corresponding to the state node having a high probability of the observed action mode being a “stationary state” indicates a location where the user remains stationary. In addition, as noted above, the location having a “stationary state” is generally a destination. Accordingly, the location at which the user remains stationary can be estimated as the destination.

The integrated learning unit 62 supplies the parameters λ of the multi-stream HMM representing the activity state of the user obtained through the learning process to the action recognition unit 53, the action estimating unit 54, and the destination estimating unit 55.

### Second Exemplary Configuration of Action Learning Unit

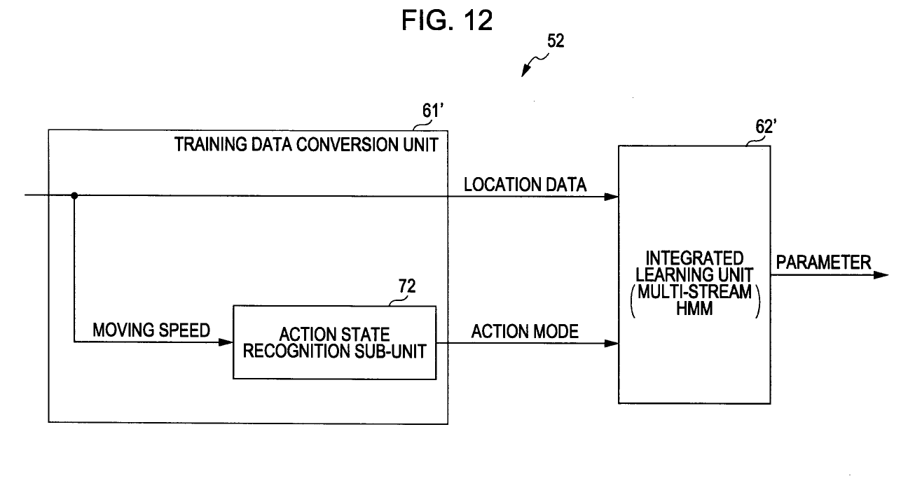

FIG. 12 is a block diagram illustrating a second exemplary configuration of the action learning unit 52 shown in FIG. 10.

As shown in FIG. 12, the action learning unit 52 includes a training data conversion unit 61′ and an integrated learning unit 62′.

The training data conversion unit 61′ includes only an action state recognition sub-unit 72 that has a configuration similar to that of the training data conversion unit 61 shown in FIG. 11. The training data conversion unit 61′ directly supplies the location data items supplied from the time-series data storage unit 51 to the integrated learning unit 62′. However, the action state recognition sub-unit 72 converts the moving speed data items supplied from the time-series data storage unit 51 into action modes and supplies the action modes to the integrated learning unit 62′.

In the first exemplary configuration of the action learning unit 52 shown in FIG. 11, the position data item is converted into a location index. Accordingly, it is difficult for the integrated learning unit 62 to reflect information indicating that a distance between different state nodes is small or large in the map on the likelihood of the learning model (the HMM). In contrast, in the second exemplary configuration of the action learning unit 52 shown in FIG. 12, the position data is directly supplied to the integrated learning unit 62′. Therefore, such distance information can be reflected on the likelihood of the learning model (the HMM).

In addition, in the first exemplary configuration, two-phase learning, that is, learning of the user activity model (the HMM) in the location index conversion sub-unit 71 and the action state recognition sub-unit 72 and learning of the user activity model in the integrated learning unit 62, is necessary. However, in the second exemplary configuration, at least the learning of the user activity model in the location index conversion sub-unit 71 is not necessary. Thus, the computing load can be reduced.

In the first exemplary configuration, the position data item is converted into a location index. Accordingly, any data including position data can be converted. However, in the second exemplary configuration, the data to be converted is limited to position data. Thus, the flexibility of processing is reduced.

The integrated learning unit 62′ learns the activity state of the user using a probabilistic state transition model (a multi-stream HMM), the time-series location data items, and a time-series discrete data of a symbol of the action mode. More specifically, the integrated learning unit 62′ learns a distribution parameter of the latitude and longitude output from each of the state nodes and the probability of the action mode.

By using the integrated model (the multi-stream HMM) obtained through the learning process performed by the integrated learning unit 62′, a state node that stochastically easily outputs an action mode of a “stationary state” can be obtained. Subsequently, the latitude and longitude distribution can be obtained using the obtained state node. Furthermore, the location of the destination can be obtained using the latitude and longitude distribution.

In this way, the location indicated by the latitude and longitude distribution and corresponding to a state node having a high probability of the observed action mode being a “stationary state” is estimated to be the location where the user remains stationary. In addition, as note above, in general, the location having a “stationary state” is a destination. Accordingly, the location where the user remains stationary can be estimated as the destination.

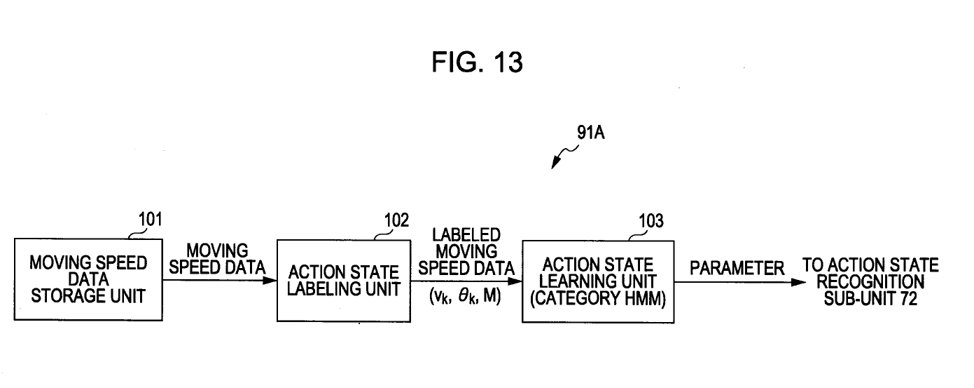

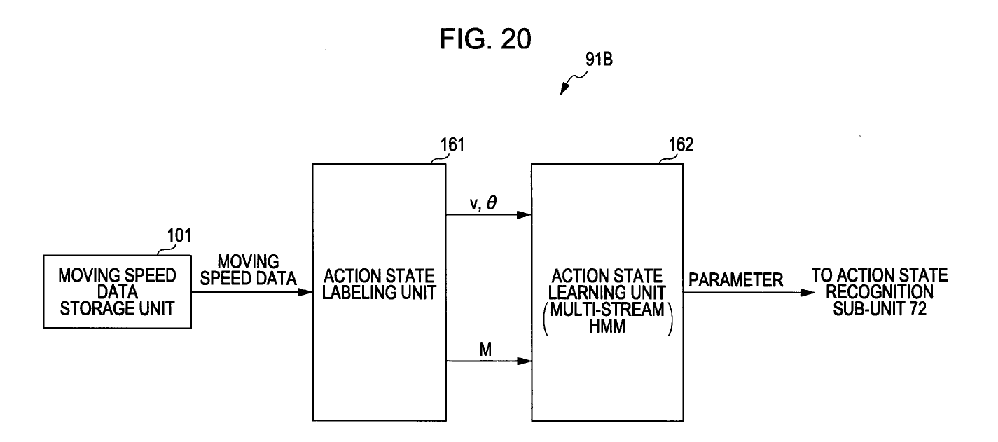

An exemplary configuration of the learner that learns the parameter of the user activity model used by the action state recognition sub-unit 72 shown in FIGS. 11 and 12 is described next. Hereinafter, as an exemplary configuration of the learner of the action state recognition sub-unit 72, a learner 91A that performs a learning process using a category HMM (see FIG. 13) and a learner 91B that performs a learning process using a multi-stream HMM (see FIG. 20) are described.

### First Exemplary Configuration of Learner of Action State Recognition Sub-Unit

FIG. 13 illustrates an exemplary configuration of the learner 91A that performs a learning process of the parameter of a user activity model used by the action state recognition sub-unit 72.

In a category HMM, a category (a class) to which the teacher data to be learned belongs has already been recognized, and the parameter of the HMM is learned for each category.

The learner 91A includes a moving speed data storage unit 101, an action state labeling unit 102, and an action state learning unit 103.

The moving speed data storage unit 101 stores time-series moving speed data items supplied from the time-series data storage unit 51 (see FIG. 10).

The action state labeling unit 102 assigns an action state of the user in the form of a label (a category) to each of the time-series moving speed data items sequentially supplied from the moving speed data storage unit 101. The action state labeling unit 102 supplies, to the action state learning unit 103, the labeled moving speed data items having an action state assigned thereto. For example, data representing a moving speed vₖ and a traveling direction θₖ in the kth step and having a label M representing the action state is supplied to the action state learning unit 103.

The action state learning unit 103 classifies the labeled moving speed data supplied from the action state labeling unit 102 into a category and learns the parameter of the user activity model (an HMM) for each of the categories. The parameter obtained through the learning process for each of the categories is supplied to the action state recognition sub-unit 72 shown in FIGS. 10 and 11.

### Example of Categories of Action State

FIG. 14 illustrates an example of the categories used when the action states are categorized.

As shown in FIG. 14, the action state of the user is categorized into the stationary state or the moving state. According to the present embodiment, as described above, it is necessary for the action state recognition sub-unit 72 to recognize at least a stationary state and a moving state as an action state of the user. Accordingly, it is necessary to categorize the action state of the user into one of these two states.

Furthermore, using the form of transportation, the moving states can be categorized into one of four types: train, motor vehicle (including a bus), bicycle, and walking. The train can be further categorized into one of three sub-types: “super express” train, “express” train, and “local” train. The motor vehicle can be further categorized into, for example, two sub-types: “expressway” and “general road”. In addition, walking can be further categorized into three sub-types: “run”, “normal”, and “stroll”.

According to the present embodiment, as shown in FIG. 14, the action state of the user is categorized into one of the following types: “stationary”, “train (express)”, “train (local)”, “motor vehicle (expressway)”, “motor vehicle (general road)”, “bicycle”, and “walking”. Note that training data for the action state “train (super express)” were unable to be acquired and, therefore, the category “train (super express)” is not used.

It should be noted that the categories are not limited to the above-described ones shown in FIG. 14. In addition, since a change in moving speed of a certain form of transportation is substantially the same for all users, the time-series moving speed data items used as the training data are not limited to those of the user to be recognized.

### Exemplary Process Performed by Action State Labeling Unit

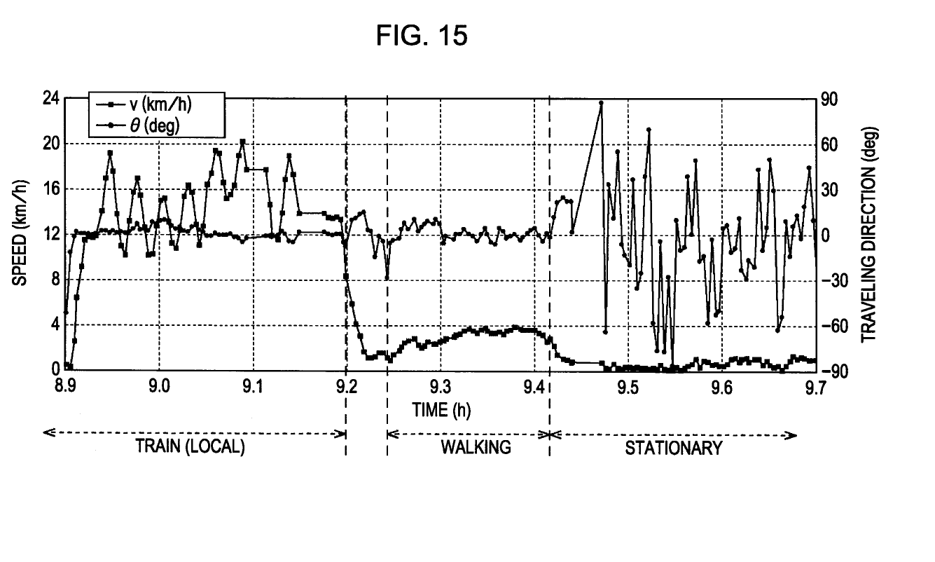

An exemplary process performed by the action state labeling unit 102 is described next with reference to FIGS. 15 and 16.

FIG. 15 illustrates an example of the time-series moving speed data supplied to the action state labeling unit 102.

In FIG. 15, the moving speed data (v, θ) supplied from the action state labeling unit 102 is shown in the form of (t, v) and (t, θ). In FIG. 15, a square plot (▪) represents a moving speed v, and a round plot () represents a traveling direction θ. In addition, the abscissa represents a time t. The ordinate on the right represents the traveling direction θ, and the ordinate on the left represents the moving speed v.

The words “train (local)”, “walking”, and “stationary” written below the time axis in FIG. 15 are shown as notes. The first time-series data in FIG. 15 is data indicating the moving speed when the user is traveling by “train (local)”. The next time-series data in FIG. 15 is data indicating the moving speed when the user is “walking”. The next time-series data in FIG. 15 is data indicating the moving speed when the user is “stationary”.

While the user is moving with a “train (local)”, the train stops at a station, accelerates when pulling out the station, and decelerates before stopping at the next station. Since this operation is repeated, the plot of the moving speed v repeatedly vertically swings. Note that the moving speed is not zero even when the train stops. This is because a filtering process using the moving average is performed.

In contrast, it is significantly difficult to distinguish the pattern of the moving speed while the user is “walking” from the pattern while the user is “stationary”. However, by performing the filtering process using the moving average, the difference between the patterns of the moving speed v is noticeable. In addition, in the pattern for “stationary”, the traveling direction θ instantaneously and significantly changes. Thus, it is easy to distinguish between these two patterns. By performing the filtering process using the moving average and representing the movement of the user in the form of the moving speed v and the traveling direction θ in this manner, “walking” can be easily distinguished from “stationary”.

Note that, in the portion between “train (local)” and “walking”, switching between the two is not clearly recognized due to the filtering process.

FIG. 16 illustrates an example in which a label is assigned to the time-series data items shown in FIG. 15.

For example, the action state labeling unit 102 displays the moving speed data shown in FIG. 15. Thereafter, the user operates, for example, mouse so as to enclose a data portion to which the user wants to assign a label with a rectangle. In addition, the user inputs the label to be assigned to the specified data using, for example, a keyboard. The action state labeling unit 102 performs a labeling process by assigning the input label to the moving speed data contained in the rectangular area specified by the user.

In FIG. 16, an example in which the moving speed data corresponding to “walking” is indicated by a rectangular area is shown. Note that, at that time, the area in which switching between the actions are not clear due to the filtering process can be excluded from the specified area. The length of the time-series data items is set to the length of the time-series data items that can be clearly distinguished from a different action. For example, the length may be set to about 20 steps (15 seconds×20 steps=300 seconds).

### Exemplary Configuration of Action State Learning Unit

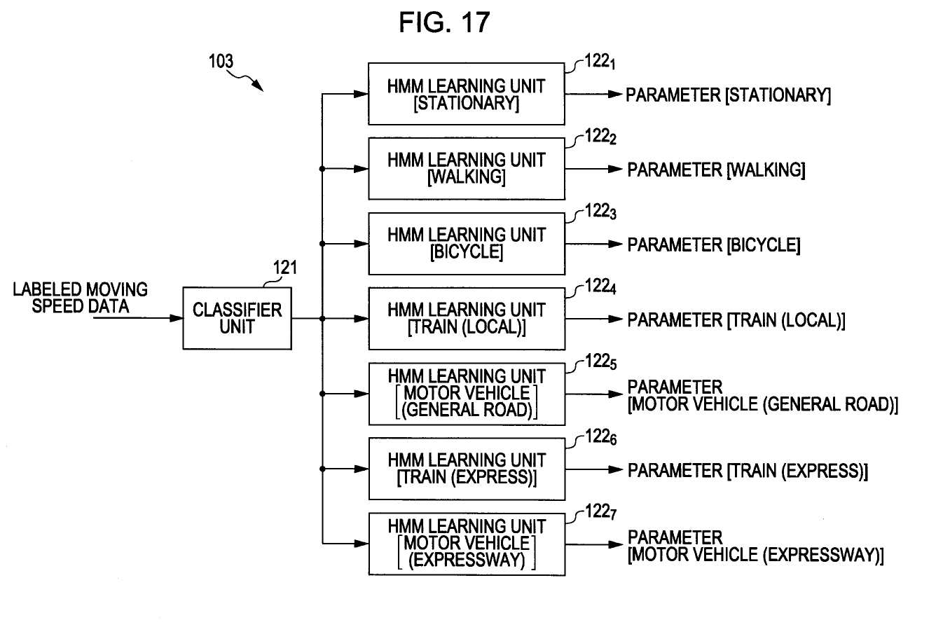

FIG. 17 is a block diagram of an exemplary configuration of the action state learning unit 103 shown in FIG. 13.

The action state learning unit 103 includes a classifier unit 121 and HMM learning units 122₁ to 122₇.

The classifier unit 121 refers to the label of the labeled moving speed data supplied from the action state labeling unit 102 and supplies the moving speed data to one of the HMM learning units 122₁ to 122₇ corresponding to the label. That is, the action state learning unit 103 includes a HMM learning unit 122 for each of the labels (the categories). The labeled moving speed data supplied from the action state labeling unit 102 is classified in accordance with the labels and is supplied.

Each of the HMM learning units 122₁ to 122₇ trains a learning model (an HMM) using the supplied labeled moving speed data items. Thereafter, each of the HMM learning units 122₁ to 122₇ supplies the parameter λ of the HMM obtained through the learning process to the action state recognition sub-unit 72 shown in FIG. 10 or 11.

The HMM learning units 122₁ trains a learning model (an HMM) for the label “stationary”. The HMM learning units 122₂ trains a learning model (an HMM) for the label “walking”. The HMM learning units 122₃ trains a learning model (an HMM) for the label “bicycle”. The HMM learning units 122₄ trains a learning model (an HMM) for the label “train (local)”. The HMM learning units 122₅ trains a learning model (an HMM) for the label “motor vehicle (general road)”. The HMM learning units 122₆ trains a learning model (an HMM) for the label “train (express)”. The HMM learning units 122₇ trains a learning model (an HMM) for the label “motor vehicle (expressway)”.

### Examples of Learning

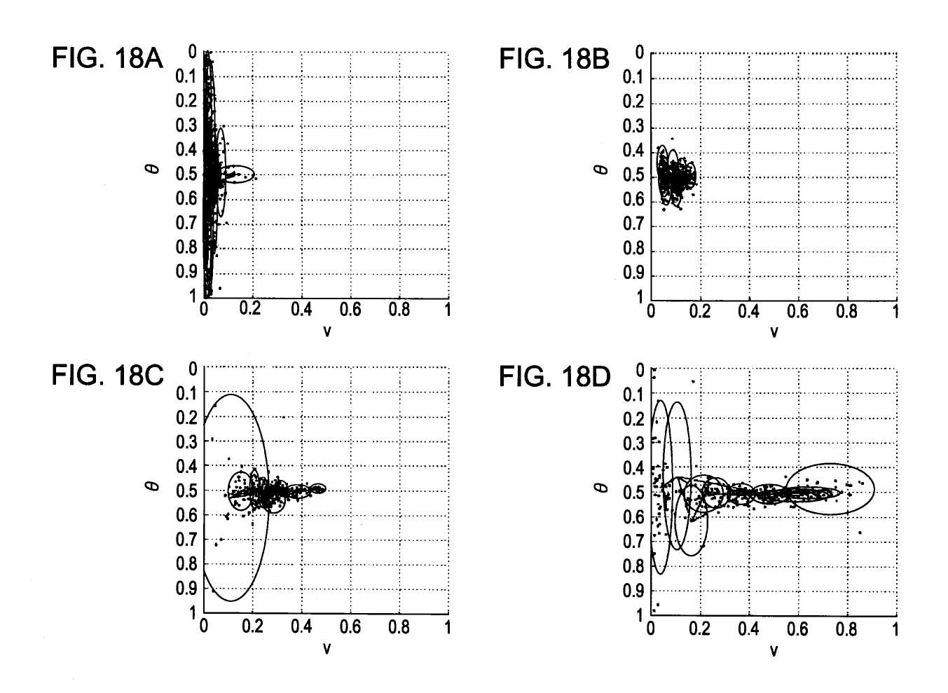

FIGS. 18A to 18D illustrate the results of learning performed by the action state learning unit 103.

FIG. 18A illustrates the result of learning performed by the HMM learning units 122₁, that is, the result of learning obtained when the label indicates “stationary”. FIG. 18B illustrates the result of learning performed by the HMM learning units 122₂, that is, the result of learning obtained when the label indicates “walking”.

FIG. 18C illustrates the result of learning performed by the HMM learning units 122₃, that is, the result of learning obtained when the label indicates “bicycle”. FIG. 18D illustrates the result of learning performed by the HMM learning units 122₄, that is, the result of learning obtained when the label indicates “train (local)”.

In FIGS. 18A to 18D, the abscissa represents the moving speed v, and the ordinate represents the traveling direction θ. The points in the graphs indicate plotted supplied training data items. The ellipses in the graphs represent the state nodes obtained through the learning process. The distribution densities of the mixed normal probability distributions are the same. Accordingly, as the size of the ellipse increases, the variance of the state node indicated by the ellipse increases.

As shown in FIG. 18A, the moving speed data items with a label of “stationary” concentrate into an area at the center of which the moving speed v is zero. In contrast, the traveling direction θ spreads throughout the area. Thus, a variation in the traveling direction θ is large.

However, as shown in FIGS. 18B to 18D, when the labels indicate “walking”, “bicycle”, and “train (local)”, a variation in the traveling direction θ is small. Accordingly, by using the variation in the traveling direction θ, the stationary state can be distinguished from the moving state.

In the moving state, the data areas having the labels “walking”, “bicycle”, and “train (local)” have different moving speeds v, and that characteristic is clearly shown in the graphs. In general, in “walking” and “bicycle”, the user moves at a constant speed. However, in “train (local)”, the speed frequently varies. Thus, a variation in speed direction is large.

In FIGS. 18A to 18D, the ellipse indicating the result of learning has a shape indicating the above-described characteristic of the plots. Consequently, it can be seen that each of the action states is correctly learned.

### First Exemplary Configuration of Action State Recognition Sub-Unit

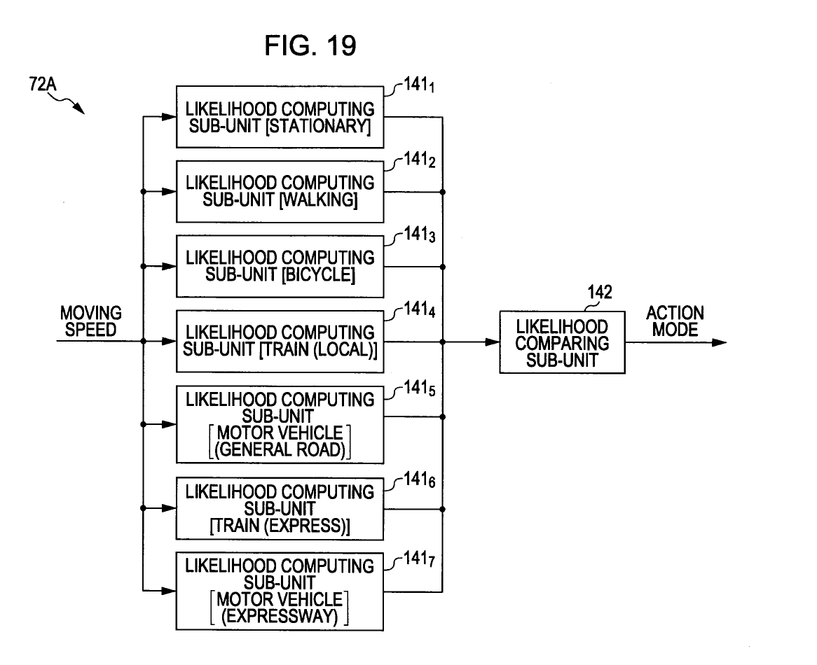

FIG. 19 is a block diagram of an action state recognition sub-unit 72A, which is the action state recognition sub-unit 72 that uses the parameter learned by the learner 91A.

The action state recognition sub-unit 72A includes likelihood computing sub-units 141₁ to 141₇ and a likelihood comparing sub-unit 142.

The likelihood computing sub-unit 141₁ computes the likelihood for the time-series moving speed data items supplied from the time-series data storage unit 51 using the parameter obtained through the learning process performed by the HMM learning unit 122₁. That is, the likelihood computing sub-unit 141₁ computes the likelihood of the action state being “stationary”.

The likelihood computing sub-unit 141₂ computes the likelihood for the time-series moving speed data items supplied from the time-series data storage unit 51 using the parameter obtained through the learning process performed by the HMM learning unit 122₂. That is, the likelihood computing sub-unit 141₂ computes the likelihood of the action state being “walking”.

The likelihood computing sub-unit 141₃ computes the likelihood for the time-series moving speed data items supplied from the time-series data storage unit 51 using the parameter obtained through the learning process performed by the HMM learning unit 122₃. That is, the likelihood computing sub-unit 141₃ computes the likelihood of the action state being “bicycle”.

The likelihood computing sub-unit 141₄ computes the likelihood for the time-series moving speed data items supplied from the time-series data storage unit 51 using the parameter obtained through the learning process performed by the HMM learning unit 122₄. That is, the likelihood computing sub-unit 141₄ computes the likelihood of the action state being “train (local)”.

The likelihood computing sub-unit 141₅ computes the likelihood for the time-series moving speed data items supplied from the time-series data storage unit 51 using the parameter obtained through the learning process performed by the HMM learning unit 122₅. That is, the likelihood computing sub-unit 141₅ computes the likelihood of the action state being “motor vehicle (general road)”.

The likelihood computing sub-unit 141₆ computes the likelihood for the time-series moving speed data items supplied from the time-series data storage unit 51 using the parameter obtained through the learning process performed by the HMM learning unit 122₆. That is, the likelihood computing sub-unit 141₆ computes the likelihood of the action state being “train (express)”.

The likelihood computing sub-unit 141₇ computes the likelihood for the time-series moving speed data items supplied from the time-series data storage unit 51 using the parameter obtained through the learning process performed by the HMM learning unit 122₇. That is, the likelihood computing sub-unit 141₇ computes the likelihood of the action state being “motor vehicle (expressway)”.

The likelihood comparing sub-unit 142 compares the likelihood values output from the likelihood computing sub-units 141₁ to 141₇ with one another. The likelihood comparing sub-unit 142 then selects the action state having the highest likelihood value and outputs the selected action state as the action mode.

### Second Exemplary Configuration of Learner of Action State Recognition Sub-Unit

FIG. 20 is a block diagram of the learner 91B that learns the parameter of a user activity model using a multi-stream HMM in the action state recognition sub-unit 72.

The learner 91A includes the moving speed data storage unit 101, an action state labeling unit 161, and an action state learning unit 162.

The action state labeling unit 161 assigns an action state of the user in the form of a label (an action mode) to each of the time-series moving speed data items sequentially supplied from the moving speed data storage unit 101. The action state labeling unit 161 supplies, to the action state learning unit 162, time-series moving speed data (v, θ) and time-series action mode-M data associated with the moving speed data.

The action state learning unit 162 learns the action state of the user using a multi-stream HMM. A multi-stream HMM can learn different types of time-series data (stream) while associating the different types of time-series data with one another. The action state learning unit 162 receives time-series data items in the form of the moving speed v and the traveling direction θ which are continuous quantities and the time-series action mode-M data which is a discrete quantity. The action state learning unit 162 learns the distribution parameter of the moving speed output from each of the state nodes and the probability of the action mode. By using the multi-stream HMM obtained through the learning process, the current state node can be obtained from the time-series moving speed data, for example. Thereafter, the action mode can be recognized using the obtained state node.

In the first exemplary configuration using a category HMM, seven HMM are necessary for the seven categories. In contrast, in the multi-stream HMM, one HMM is sufficient. However, a number of state nodes substantially equal to the total number of state nodes used in the seven categories of the first exemplary configuration are necessary.

### Exemplary Processing Performed by Action State Labeling Unit

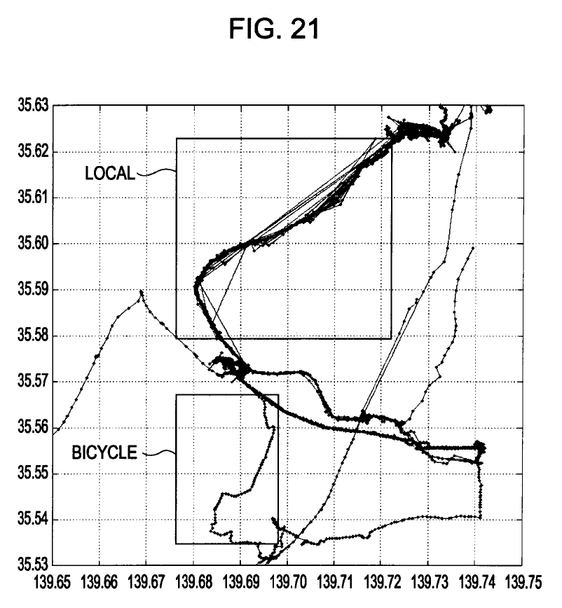

Exemplary processing performed by the action state labeling unit 161 is described next with reference to FIG. 21.

In the labeling method for use in the action state labeling unit 102 having the above-described first exemplary configuration, information regarding a change in the form of transportation is lost. Accordingly, a change in the form of transportation that rarely occurs may occur. The action state labeling unit 161 assigns a label indicating the action state of the user to the moving speed data without losing information regarding a change in the form of transportation.

More specifically, when the user sees the places (the locations) instead of the moving speeds, the user can easily recognize the action of the user at the place. Accordingly, the action state labeling unit 161 presents the location data items corresponding to the time-series moving speed data items to the user and allows the user to assign a label to the location. Thus, the action state labeling unit 161 assigns the label indicating an action state to the time-series moving speed data items.

In the example shown in FIG. 21, location data items corresponding to the time-series moving speed data items are displayed on a map having the abscissa representing the latitude and the ordinate representing the longitude. The user encloses an area corresponding to a given action state with a rectangle by using, for example, a mouse. In addition, the user inputs a label to be assigned to the specified area by using, for example, a keyboard. The action state labeling unit 161 then assigns the input label to the time-series moving speed data items corresponding to the plotted points in the rectangular enclosed area. In this way, labeling is performed.

In FIG. 21, an example in which the portions corresponding to “train (local)” and “bicycle” are selected by enclosing the portions with rectangular frames is shown.

Note that, in FIG. 21, all of the input time-series data items are displayed. However, if the number of the data items is large, the data items may be displayed for, for example, every 20 steps and labeling for the displayed data items may be sequentially repeated. Alternatively, the user may prepare an application to perform labeling on previous data items in the same manner as the user reads their diary and remembers the actions in the past. That is, the labeling method is not limited to any particular method. In addition, a user who does not generate the data may perform labeling.

### Example of Result of Learning

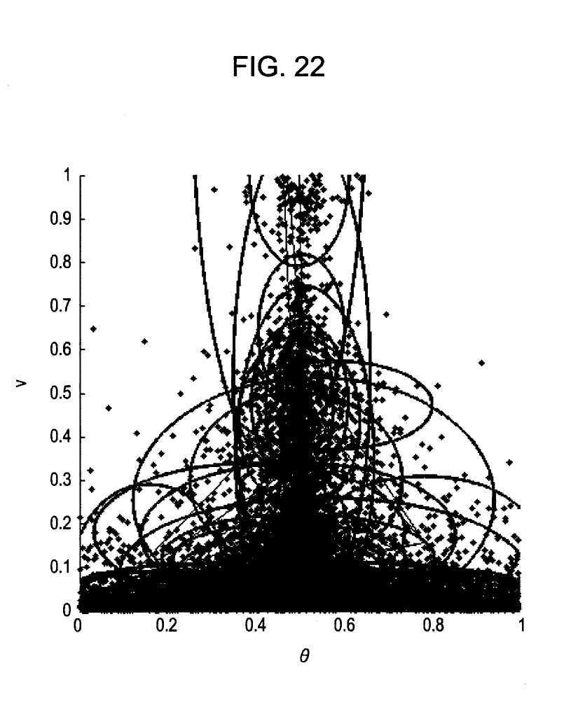

FIG. 22 illustrates an example of the result of learning performed by the action state learning unit 162.

In FIG. 22, the abscissa represents the traveling direction θ, and the ordinate represents the moving speed v. The points in the graphs indicate plotted supplied training data items. The ellipses in the graphs represent the state nodes obtained through the learning process. The distribution densities of the mixed normal probability distributions are the same. Accordingly, as the size of the ellipse increases, the variance of the state node indicated by the ellipse increases. The state node in FIG. 22 corresponds to the moving speed. Although not shown in FIG. 22, the observation probability of the action node is attached to each of the state nodes, and the learning process is performed.

### Second Exemplary Configuration of Action State Recognition Sub-Unit

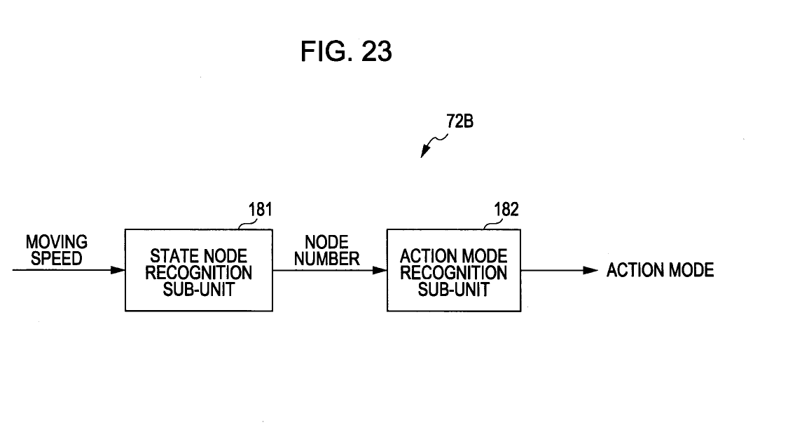

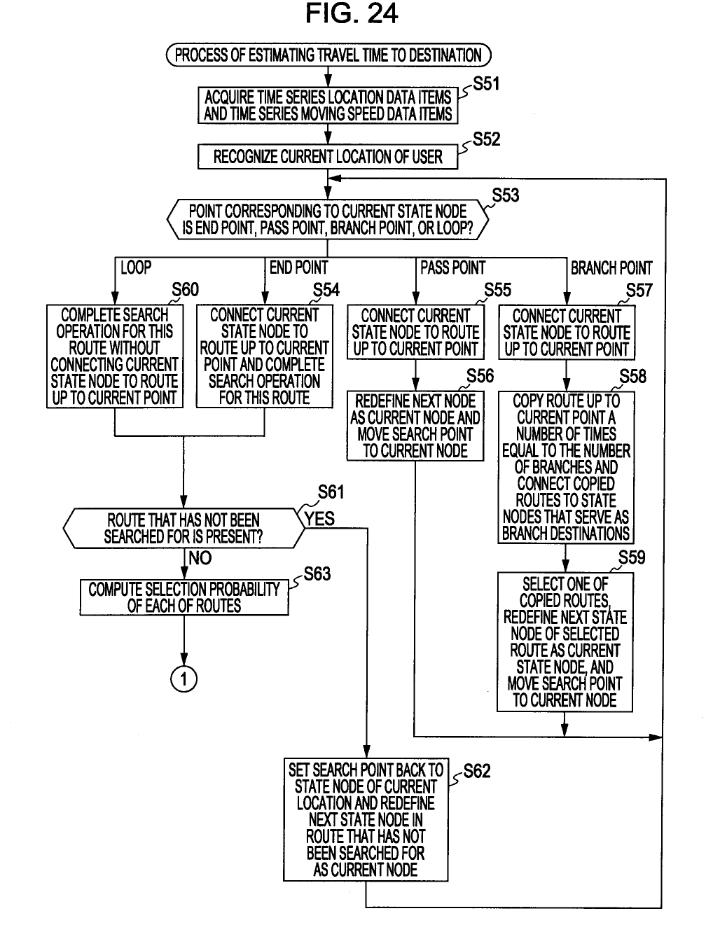

FIG. 23 is a block diagram of an action state recognition sub-unit 72B, which is the action state recognition sub-unit 72 that uses the parameter learned by the learner 91B.

The action state recognition sub-unit 72B includes a state node recognition sub-unit 181 and an action mode recognition sub-unit 182.

The state node recognition sub-unit 181 recognizes the state node of the multi-stream HMM using the parameter of the multi-stream HMM learned by the learner 91B and the time-series moving speed data supplied from the time-series data storage unit 51. Thereafter, the state node recognition sub-unit 181 supplies the node number of the current recognized state node to the action mode recognition sub-unit 182.

From among the state nodes recognized by the state node recognition sub-unit 181, the action mode recognition sub-unit 182 selects the action mode having the highest probability as the current action mode and outputs the action mode.

Note that, in the above-described example, by generating an HMM model in the location index conversion sub-unit 71 and the action state recognition sub-unit 72, the location data and moving speed data supplied from the time-series data storage unit 51 are converted into the location index data and the action mode data, respectively.

However, by using a method other than the above-described method, the location data and moving speed data may be converted into the location index data and the action mode data, respectively. For example, the action mode may be determined by detecting whether the user moved using the result of detection of acceleration output from a motion sensor (e.g., an acceleration sensor or a gyro sensor) disposed in addition to the GPS sensor 11.

### Estimation Process of Travel Time to Destination

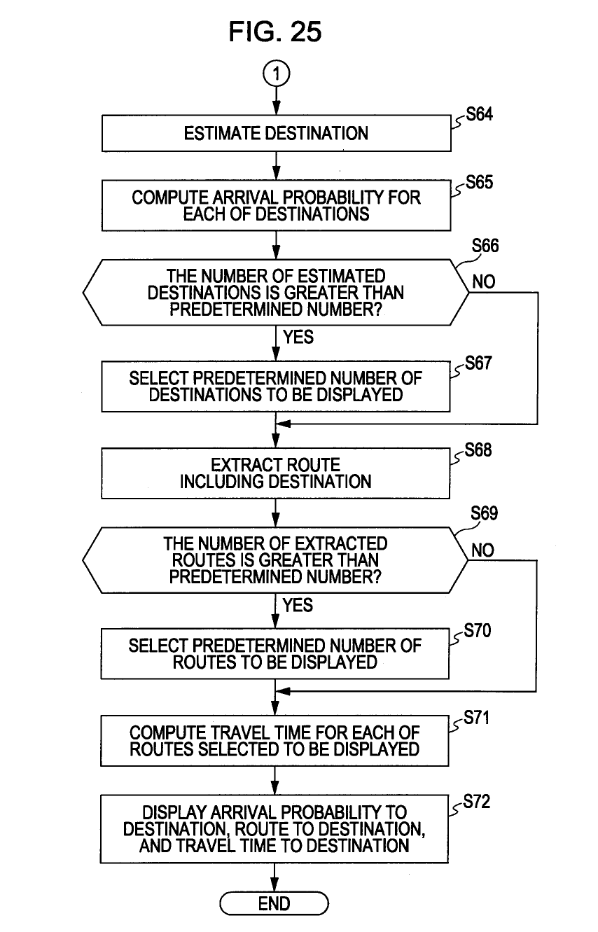

An exemplary estimation process of a travel time to a destination performed by the estimation system 1 shown in FIG. 10 is described next with reference to FIGS. 24 and 25.

That is, FIGS. 24 and 25 are flowcharts of the estimation process of a travel time to a destination in which the destination is estimated using the time-series location data and the time-series moving speed data, the route and the travel time to the destination are computed, and the result of the computation is presented to the user.

The processes performed in steps S51 to S63 shown in FIG. 24 are similar to those in steps S21 to S33 of the travel time estimation process shown in FIG. 9 except that the time-series data acquired in step S51 is replaced with the time-series location and moving speed data. Accordingly, the descriptions thereof are not repeated.

Through the processes in steps S51 to S63 shown in FIG. 24, the current location of the user is recognized. Thereafter, all of the possible routes for the user are searched for without excess and shortage, and the selection probabilities of the routes are computed. Subsequently, the processing proceeds to step S64 shown in FIG. 25.

In step S64, the destination estimating unit 55 estimates the destination of the user. More specifically, the destination estimating unit 55 lists the candidates of the destination first. Thereafter, the destination estimating unit 55 selects the locations at which the action state of the user is a “stationary” state as the candidates of the destination. Subsequently, from among the listed candidates of the destination, the destination estimating unit 55 determines, as destinations, the candidates of destination located in the routes found by the action estimating unit 54.

In step S65, the destination estimating unit 55 computes the arrival probability for each of the destinations. That is, for the destination having a plurality of routes, the destination estimating unit 55 computes the sum of the selection probabilities of the plurality of routes as the arrival probability of the destination. If the destination has only one route, the selection probability of the route serves as the arrival probability of the destination.

In step S66, the destination estimating unit 55 determines whether the number of the estimated destinations is greater than a predetermined number. If, in step S66, the number of the estimated destinations is greater than a predetermined number, the processing proceeds to step S67, where the destination estimating unit 55 selects a predetermined number of destinations to be displayed on the display unit 18. For example, the destination estimating unit 55 can select the predetermined number of destinations in order from the destination having the highest arrival probability to the lowest.

However, if, in step S66, the number of the estimated destinations is less than or equal to a predetermined number, step S67 is skipped. That is, in this case, all of the estimated destinations are displayed on the display unit 18.

In step S68, the destination estimating unit 55 extracts, from among the routes searched for by the action estimating unit 54, the route including the estimated destination. If a plurality of destinations are estimated, the routes to each of the estimated destinations are extracted.

In step S69, the destination estimating unit 55 determines whether the number of the extracted routes is greater than the predetermined number of routes to be presented to the user.

If, in step S69, the number of the extracted routes is greater than the predetermined number, the processing proceeds to step S70, where the destination estimating unit 55 selects a predetermined number of routes to be displayed on the display unit 18. For example, the destination estimating unit 55 can select a predetermined number of routes in order from the route having the highest selection probability to the lowest.

However, if, in step S69, the number of the extracted routes is less than or equal to the predetermined number, step S70 is skipped. That is, in this case, all of the routes to the destination are displayed on the display unit 18.

In step S71, the destination estimating unit 55 computes a travel time for each of the routes determined to be displayed on the display unit 18 and supplies, to the display unit 18, the signal of an image indicating the arrival probability to the destination, the route to the destination, and the travel time to the destination.

In step S72, the display unit 18 displays the arrival probability to the destination, the route to the destination, and the travel time to the destination using the signal supplied from the destination estimating unit 55. Subsequently, the process is completed.

As described above, according to the estimation system 1 shown in FIG. 10, the destination is estimated using the time-series location data items and time-series moving speed data items. In addition, the arrival probability of the destination, the route to the destination, and the travel time to the destination can be computed and presented to the user.

### Example of Result of Process Performed by Estimation System

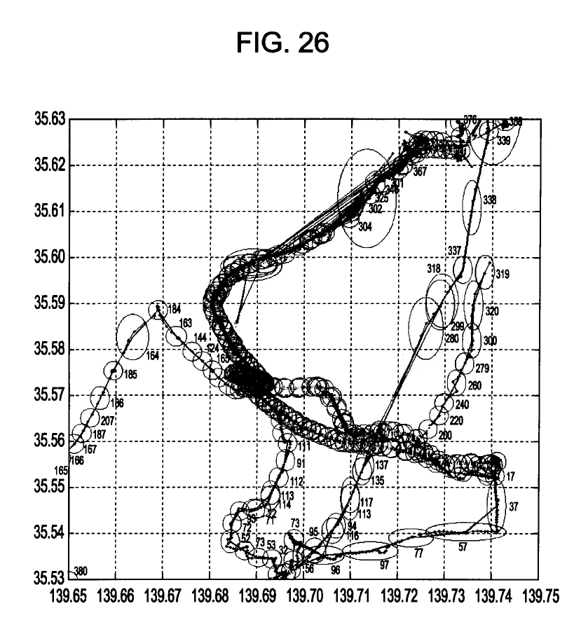

FIGS. 26 to 29 illustrate an example of the result of a verification experiment for verifying the learning process and the process of estimating the travel time to the destination performed by the estimation system 1 shown in FIG. 10. Note that the data shown in FIG. 3 is used as training data for the learning process performed by the estimation system 1.

FIG. 26 illustrates the result of learning of the parameter input to the location index conversion sub-unit 71 shown in FIG. 11.

In this verification experiment, the number of state nodes is 400. In FIG. 26, the number attached to an ellipse representing a state node indicates the node number of the state node. According to the learned multi-stream HMM shown in FIG. 26, the state nodes are learned so that the travel route of the user is covered. That is, it can be seen that the travel route of the user is correctly learned. The node number of this state node is input to the integrated learning unit 62 as a location index.

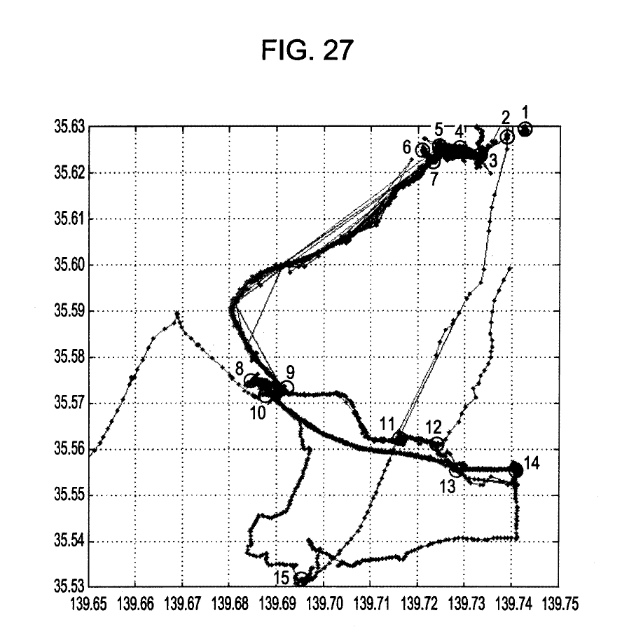

FIG. 27 illustrates the result of learning the parameter input to the action state recognition sub-unit 72 shown in FIG. 11.

In FIG. 27, a point (a location) having an action mode recognized as “stationary” is plotted using a black color. In addition, a point having an action mode recognized as a mode other than “stationary” (e.g., “walking” or “train (local)”) is plotted using a gray color.

Furthermore, in FIG. 27, the locations listed up as the locations at which the experimenter that generated the learning data remains stationary are indicated by circles (◯). The number attached to the circle serves as an ordinal number used for distinguishing between the locations.

As shown in FIG. 27, the locations indicating the stationary state determined through the learning process are the same as the locations listed up as the locations at which the experimenter remains stationary. Thus, it can be seen that the action state (the action mode) of the user is correctly learned.

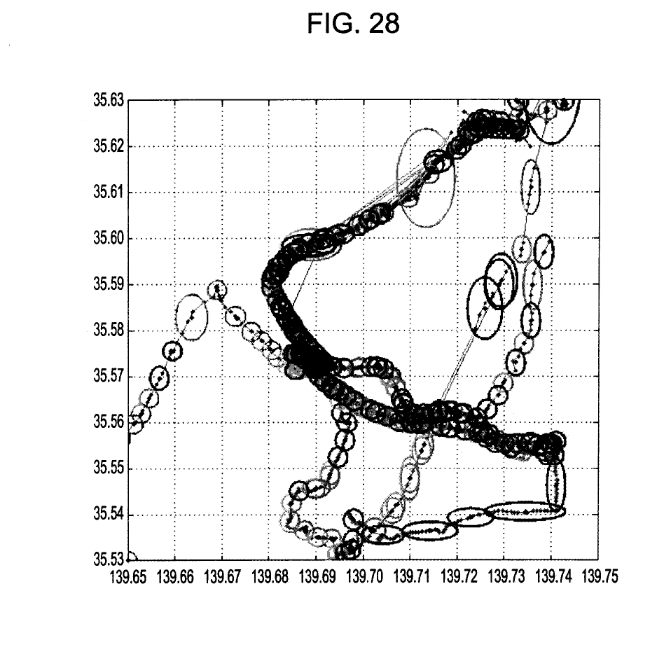

FIG. 28 illustrates the result of learning performed by the integrated learning unit 62.

Although the details are not clearly shown in FIG. 28 for simplicity, the state nodes having an observation probability “stationary” of 50% or more among the state nodes of the stream HMM correspond to the locations shown in FIG. 27.

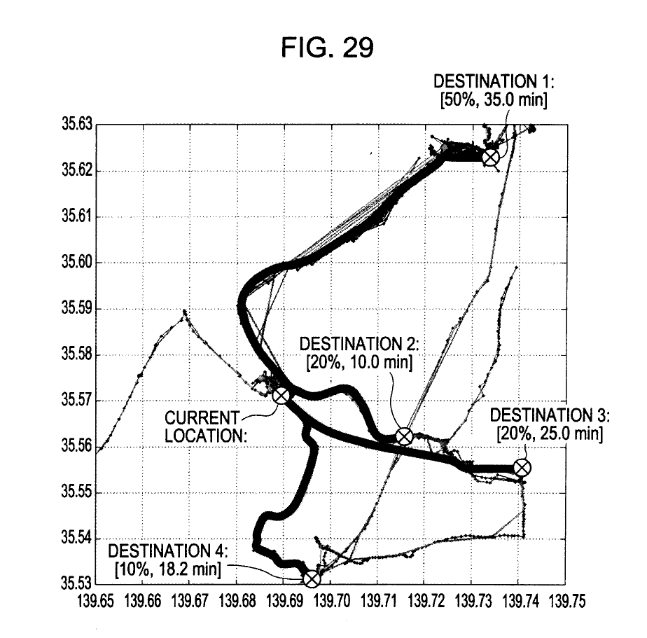

FIG. 29 illustrates the result of the performance of the process of estimating the travel time to the destination shown in FIGS. 24 and 25 using the learning model (the multi-stream HMM) trained in the integrated learning unit 62.

According to the result shown in FIG. 29, using the current location, the destinations to visit 1 to 4 shown in FIG. 3 are estimated as the destinations 1 to 4, respectively. In addition, the arrival probabilities at the destinations and the arrival times to the destinations are computed.

The arrival probability at the destination 1 is 50%, and the travel time to the destination 1 is 35 minutes. The arrival probability at the destination 2 is 20%, and the travel time to the destination 2 is 10 minutes. The arrival probability at the destination 3 is 20%, and the travel time to the destination 3 is 25 minutes. The arrival probability at the destination 4 is 10%, and the travel time to the destination 4 is 18.2 minutes. Note that the routes to the destinations 1 to 4 are indicated by bold solid lines.

Accordingly, the estimation system 1 shown in FIG. 10 can estimate the destinations of the user starting from the current location of the user and can further estimate the routes to the destinations and the travel times to the destinations. Subsequently, the estimation system 1 can present the result of estimation to the user.

While the example above has been described with reference to estimation of the destination of the user using the action state of the user, a method for estimating the destination is not limited thereto. For example, the destination may be estimated using the locations of the destinations that have been input by the user in the past.

The estimation system 1 shown in FIG. 10 can further instruct the display unit 18 to display the information regarding the destination having the highest arrival probability. For example, if the destination represents a railway station, the estimation system 1 can cause the display unit 18 to display the train schedule of the railway station. If the destination represents a store, the estimation system 1 can cause the display unit 18 to display the detailed information about the store (e.g., the store hours or low price information). In this way, a convenience for the user can be further increased.

In addition, if additional time-series data items that have an impact on the action of the user are input to the estimation system 1 shown in FIG. 10, the estimation system 1 can perform conditional estimation of the action. For example, when the data on the day of week (weekday/weekend) is input and if the estimation system 1 performs a learning process, the destination can be estimated when the user takes different actions (different destinations) on different days of week. Alternatively, when the data on a time zone (morning/afternoon/nighttime) is input and if the estimation system 1 performs a learning process, the destination can be estimated when the user takes different actions (different destinations) in different time zones. Still alternatively, when the data on weather (clear/cloudy/rainy) is input and if the estimation system 1 performs a learning process, the destination can be estimated when the user selects different destinations in different weather conditions.

Note that, in the above-described embodiment, in order to convert the moving speed into an action mode and input the action mode to the integrated learning unit 62 or the integrated learning unit 62′, the action state recognition sub-unit 72 is provided. However, the action state recognition sub-unit 72 can be used as a stand-alone unit for recognizing whether a user is in a moving state or in a stationary state using an input moving speed, further recognizing which form of transportation is used by the user if the user is in a moving state, and outputting the result of recognition. In such a case, the output of the action state recognition sub-unit 72 can be input to another application.

The above-described series of processes can be executed not only by hardware but also by software. When the above-described series of processes are executed by software, the programs of the software are installed in a computer. The computer may be in the form of a computer embedded in dedicated hardware or a computer that can execute a variety of functions by installing a variety of programs therein (e.g., a general-purpose personal computer).

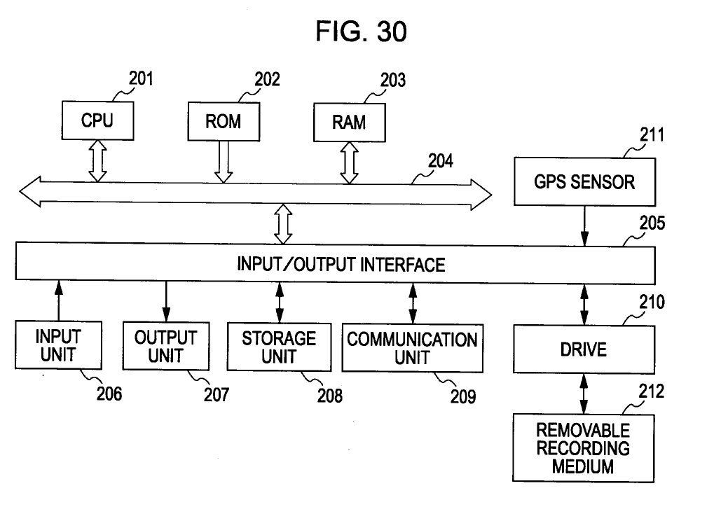

FIG. 30 is a block diagram of an exemplary hardware configuration of a computer that performs the above-described series of processes using computer programs.

In the computer, a central processing unit (CPU) 201, a read only memory (ROM) 202, and a random access memory (RAM) 203 are connected to one another via a bus 204.

In addition, an input/output interface 205 is connected to the bus 204. An input unit 206, an output unit 207, a storage unit 208, a communication unit 209, a drive 210, and a GPS sensor 211 are connected to the input/output interface 205.

The input unit 206 includes, for example, a keyboard, a mouse, and a microphone. The output unit 207 includes, for example, a display and a speaker. The storage unit 208 includes a hard disk and a nonvolatile memory. The communication unit 209 includes, for example, a network interface. The drive 210 drives a removable recording medium 212, such as a magnetic disk, an optical disk, a magnetooptical disk, or a semiconductor memory. The GPS sensor 211 corresponds to the GPS sensor 11 shown in FIG. 1.

In the computer having such a hardware configuration, the CPU 201 loads a program stored in the storage unit 208 into the RAM 203 via the input/output interface 205 and the bus 204 and executes the program. In this way, the above-described series of processes are performed.

A program executed by the computer (the CPU 201) can be recorded in the removable recording medium 212 in the form of, for example, a packaged medium and can be provided to the computer. In addition, the programs can be provided via a wired or wireless transmission medium, such as a local area network, the Internet, and a digital satellite broadcast.

By mounting the removable recording medium 212 in the drive 210 of the computer, the program can be installed in the storage unit 208 via the input/output interface 205. Alternatively, the program can be received by the communication unit 209 via a wired or wireless transmission medium and can be installed in the storage unit 208. Still alternatively, the programs can be preinstalled in the ROM 202 or the storage unit 208.

Note that the programs executed by the computer may be sequentially executed in the order described in the above-described embodiment, may be executed in parallel, or may be executed at appropriate points in time, such as when the programs are called.

In addition, the steps illustrated in the flowcharts of the above-described embodiment may be executed in the order described in the embodiment, may be executed in parallel, or may be executed at appropriate points in time, such as when the steps are called.

Note that, as used herein, the term “system” refers to a combination of a plurality of apparatuses.

The present application contains subject matter related to that disclosed in Japanese Priority Patent Application JP 2009-208064 filed in the Japan Patent Office on Sep. 9, 2009, the entire content of which is hereby incorporated by reference.

It should be understood by those skilled in the art that the embodiments of the present invention are not limited to the above-described embodiments, and various modifications can be made without departing from the spirit and scope of the invention.

What is claimed is:

1. A data processing apparatus comprising:
action learning means for training a user activity model representing activity states of a user in the form of a probabilistic state transition model using time-series location data items of the user;
action recognizing means for recognizing a current location of the user using the user activity model obtained through the action learning means;
action estimating means for estimating a possible route for the user from the current location recognized by the action recognizing means and a selection probability of the route; and
travel time estimating means for estimating an arrival probability of the user arriving at a destination and a travel time to the destination using the estimated route and the estimated selection probability.

2. The data processing apparatus according to claim 1, wherein the action learning means uses a hidden Markov model as the probabilistic state transition model for learning the time-series data items and computes a parameter of the hidden Markov model so that a likelihood of the hidden Markov model is maximized.

3. The data processing apparatus according to claim 2, wherein the action recognizing means recognizes the current location of the user by finding a state node corresponding to the current location of the user.

4. The data processing apparatus according to claim 3, wherein the action estimating means searches for all of possible routes by defining the state node corresponding to the current location as a start point of the route and defining a state node that allows state transition from a previous node as a next point to which user moves, and wherein the action estimating means computes a selection probability of each of the searched routes.

5. The data processing apparatus according to claim 4, wherein the action estimating means completes the search for a route if an end point or a point that appeared in a route that has already been traversed appears in the searched route.

6. The data processing apparatus according to claim 5, wherein the action estimating means computes the selection probability of the route by sequentially multiplying a transition probability for every state node that forms the route, where the transition probability is normalized after excluding a self-transition probability from a state transition probability of each of the nodes obtained through a learning process.

7. The data processing apparatus according to claim 6, wherein, if a plurality of routes to the destination are found, the travel time estimating means estimates the arrival probability of the user arriving at the destination by computing a sum of the selection probabilities of the routes to the destination.

8. The data processing apparatus according to claim 6, wherein the travel time estimating means estimates a travel time necessary for the estimated route as an expected value of a period of time from a current point in time to when a state transition occurs from a state node immediately preceding the state node corresponding to the destination to the state node corresponding to the destination.

9. The data processing apparatus according to claim 1, wherein the action learning means trains the user activity model using time-series moving speed data items of the user in addition to the time-series location data items of the user, and wherein the action recognizing means further recognizes the action state of the user representing one of at least a moving state and a stationary state.

10. The data processing apparatus according to claim 9, wherein the travel time estimating means further estimates, as the destination, a state node at which the action state of the user represents the stationary state.

11. The data processing apparatus according to claim 9, wherein the action learning means classifies the time-series moving speed data items for each of the action states in advance and learns different parameters of the same probabilistic state transition model for the action states, and wherein the action recognizing means selects, from among the user activity models for the action states, the action state having the highest likelihood as the action state of the user.

12. The data processing apparatus according to claim 9, wherein the action learning means trains the probabilistic state transition model so that the time-series moving speed data items are associated with corresponding time-series user action state data items having the same time information, and wherein the action recognizing means recognizes, from among the state nodes of the probabilistic state transition model corresponding to the time-series moving speed data items, the state node having the highest likelihood and selects, from among the recognized state nodes, the state node having the highest probability as an action state of the user.

13. The data processing apparatus according to claim 9, wherein the action learning means trains the user activity model by using additional time-series condition data items that have an impact on the location and action state of the user, and wherein the action recognizing means recognizes the location and the action state of the user under a current action condition.

14. A data processing method for use in a data processing apparatus that processes time-series data items, comprising the steps of:
training a user activity model representing activity states of a user in the form of a probabilistic state transition model using time-series location data items of the user;
recognizing a current location of the user using the user activity model obtained through learning;
estimating a possible route for the user from the recognized current location of the user and a selection probability of the route; and
estimating an arrival probability of the user arriving at a destination and a travel time to the destination using the estimated route and the estimated selection probability.

15. A program comprising:
program code for causing a computer to function as action learning means for training a user activity model representing activity states of a user in the form of a probabilistic state transition model using time-series location data items of the user, action recognizing means for recognizing a current location of the user using the user activity model obtained through the action learning means, action estimating means for estimating a possible route for the user from the current location recognized by the action recognizing means and a selection probability of the route, and travel time estimating means for estimating an arrival probability of the user arriving at a destination and a travel time to the destination using the estimated route and the estimated selection probability.

16. A data processing apparatus comprising:
an action learning unit configured to train a user activity model representing activity states of a user in the form of a probabilistic state transition model using time-series location data items of the user;
an action recognizing unit configured to recognize a current location of the user using the user activity model obtained through the action learning unit;
an action estimating unit configured to estimate a possible route for the user from the current location recognized by the action recognizing unit and a selection probability of the route; and
a travel time estimating unit configured to estimate an arrival probability of the user arriving at a destination and a travel time to the destination using the estimated route and the estimated selection probability.
